(19) United States
(12) Patent Application Publication
(10) Pub. No.: US 2006/0058966 A1
(43) Pub. Date: Mar. 16, 2006

(54) Methods and systems for guiding selection of chemotherapeutic agents

(76) Inventor: Howard W. Bruckner, New York, NY (US)

Correspondence Address: James Remenick;Powell Goldstein LLP, Intellectual Property Group, 901 New York Avenue, N.W., Third Floor, Washington, DC, 20001-4413, US

(21) Appl. No.: 10/941,089

(22) Filed: Sep. 15, 2004

(51) Int. Cl. G06F 19/00

(52) U.S. Cl. 702/19; 705/3

(57) ABSTRACT

The present invention relates to a systems and methods for selecting agents and combinations of agents for treatment of particular cancer patients or selected groups of cancer patients. These methods of the invention index possible agents and combinations in a ranking indicating the likelihood of their usefulness in the particular patient or group of patients. The indexing depends on chemo-sensitivity/resistance assays data for the agents and combinations themselves, supplemented by reference data obtained from assaying the same and other agents and combinations against clinically similar tumors, and on overall clinical response rates for the agents and combinations. These methods include additional new indexing criteria which supplement or replace previous criteria in order to provide for more complex, informative and quantitative analysis of potential treatments for single patients or groups of patients. The new criteria, and the methods and the present invention generally, are based on new discoveries and insights concerning the action and interaction of chemotherapeutic agents, including for example, recognition of the common heterogeneity of tumors heretofore considered empirically substantially homogeneous. Systems of the invention provide access to significant reference data and implement the methods of the invention in a manner for use by physicians and other health professionals. In further embodiment, these method and systems provide for screening of new agents and new combinations including, perhaps, old agents in a manner that can detect activity even if overall clinical response rates are not encouraging.

### BACKGROUND

1. Field of the Invention

The present invention relates to the field of oncology or cancer treatment. More particularly, the present invention relates to methods and systems for selecting or screening a chemotherapeutic agent, or combinations of chemotherapeutic agents for treatment of individual cancer patients or groups of cancer patients, the selection of chemotherapeutic agents being guided by, for example, data from chemo-sensitivity/resistance assays, the selection of patient groups being guided by, for example, one or more of particular tumor types, or past treatments, or intended future treatments

2. Description of the Background

The origin of in vitro drug-response testing and drug discovery stems from the work of Ehrlich and Pasteur, who evaluated agents of microbial and synthetic origin on the growth of cultured microbes in the 1870s. Ehrlich coined the term chemotherapy and emphasized the need for agents that were selectively toxic for the pathogenic organism. It has long been the standard of care in infectious disease that the clinicians determine the sensitivity and resistance of an organism before treatment.

However, the selection of a chemotherapy regimen for an individual tumor is almost always based on its tumor histology in view of prior clinical studies of the chemotherapeutic efficacy for groups of patients with histologically similar tumors. Since individuals with the same histology often respond differently to the same chemotherapy regimen, presumably due to tumor heterogeneity, no single regimen has ever been shown to be universally, or nearly universally, effective in patients with common tumor types. Also for uncommon tumor types and for those for which empirical therapy already produces high rates of response and cure, there are many patients with resistant tumors, and it is individually significant to improve selection of treatment and quality of life for those patients as well.

Discoveries of and improvements in tissue culture technology paved the way for an attempt in the 1950s to translate the approach for infectious diseases to oncology. See, e.g., Wright et al., 1957, N. Eng. J. Med., 252:1207-1211; Black et al., 1954, J. Natl. Cancer Inst., 14:1147. In vitro tumor chemo-sensitivity assays using tissue culture technology were developed in an attempt to identify those agents or combinations active against a particular patient's tumor to enable the oncologist to individualize treatment. A number of review articles are available. See, e.g., Fruehauf et al., 1993, Principles and Practice of Oncology 1:12; Yon Hoff, 1990, J. Natl. Cancer Inst., 82:96-101; Cree et al., 1997, Anti-Cancer Drugs, 8:541-548; Bosanquet, 1993, Clin. Oncol., 5:195-197.

Unfortunately despite the development of numerous in vitro tumor chemosensitivity assay systems, their use has had, at best, sporadic clinical success in selecting chemotherapeutic regimens for patients. Some of these unsuccessful assay systems are described herein.

In Vitro Assay Methods

Beginning in 1954, Black and Spear compared clinical outcomes with the response of patients' tumors in vitro in a succinate dehydrogenase-dependent dye-reduction assay system. See, e.g., Black et al., 1954, J. Natl. Cancer Inst., 14:1147. This small study suggested that the test had predictive accuracy for resistance but not for sensitivity. After various improvements, their technique evolved into the tetrazolium dye (MTT) assay, which was incorporated into the National Cancer Institute cancer drug discovery and development program, and provides a technology that is reproducible between laboratories but is limited to testing cell lines rather than patient tumors of heterogeneous cell content. See, e.g., Fruehauf et al., 1993, Principles and Practice of Oncology 7: 12.

A second significant attempt to develop a reliable in vitro drug-response method, the clonogenic assay, evaluates the ability of chemotherapeutic agents to inhibit tumor stem cell proliferation in agar. The method generally uses colony counting, or determination of colony-forming units, after drug exposure. See, e.g., Hamburger et al., 1977, Science, 197:461-463; Hamburger et al., 1977, J. Clin. Invest, 60:846-854; Yon Hoff, et al., 1990, J. Natl. Cancer Inst. 82:110-116. However, technical problems were identified that made in vitro modeling of patient response difficult, and that called into question the entire concept of using in vitro methods to predict the drug response of patients. See, e.g., Selby et al., 1983, N. Eng. J. Med., 308:129: VonHoff, 1990, J. Nat'l. Cancer Inst., 82:96-101; VonHoffet al., 1990, J. Nat'l. Cancer Inst., 82(2):110-116; Hansuke et al., 1989, Sci. Cancer Ther., 2(3):92-111. Instead of colony counting, tritiated thymidine incorporation to measure DNA synthesis also can be used in the clonogenic assay system. See, e.g., Sondak et al., 1984, Cancer Res., 44: 1725; Kern and Weisenthal (Kern et al., 1990, J. Natl Cancer Inst., 82:582. The thymidine incorporation assay usually uses a longer (and greater, or “extreme”) drug exposure than the clonogenic assay in a method commonly known as an “Extreme Drug Resistance” (EDR) type assay.

Another assay, the DiSC assay, uses cells isolated from tumor specimens, to measure cell kill in a largely non-dividing tumor cell population by selective staining and counting, and has been used for the study of solid tumors as well as hematopoietic malignancies. See, e.g., Weisenthal et al., 1991, Oncology. 5:93-103; Bosanquet et al., 1993, The DiSC assay: 10 years and 2000 tests further on. In Kaspers G. I. L., et al. (Eds): The clinical value of drug resistance assays in leukemia and lymphoma, p. 373. London, Harwood). However, the DiSC assay has also been developed as an Extreme Drug Resistance type assay (EDR), and depends on recognition of resistance to a single drug at high drug concentrations.

A further assay, the tissue explant assay, keeps the three-dimensional architecture of the tumor intact during incubation in an attempt to solve the technical difficulties inherent in single-cell suspension assays. In this assay, pieces of tumor are chopped into approximately 1-2 mm diameter pieces and supported on a collagen matrix; cell survival after incubation with drugs can be assessed by a variety of means, such as tritiated thymidine incorporation, autoradiography, or MTT reduction. See, e.g., Hoffman et al., 1991, Cancer Cells, 1:86; Furkawa et al., 1992, Cancer, 51:489; Robbins et al., 1991, Arch Otolaryngol Head Neck Surg, 117:83. However, a large sample size is required, and there are also unresolved technical problems in consistently selecting the size of the explant, proof of ideal size, and rate of successful assay.

A final unsuccessful assay described herein uses the intracellular conversion of fluorescein monoacetate into fluorescent derivatives in a microorgan culture system, in which tissues are incubated with treatment drugs to determine cell viability. See, e.g., Meitner et al., 1991, Oncology, 75-81; Rotman, 1989, Proc. Am. Assoc. Cancer Res., 30:654-655; Rotman et al., 1987, Pro. Am. Assoc. Cancer Res., 28:1677). This assay has been limited to tests of single drugs in vitro, without clinical application.

For all these reasons, these assay methods have failed to win general acceptance of the FDA expert review boards or notably expert practitioners.

ATP-TCA Assay Method

A further assay, the ATP-TCA assay, described herein, has demonstrated correlation with clinical results relating to a few single agents, but no methods have arisen which permits its systematic and routine use for selecting therapy with reproducible clinical results, especially for combinations of agents. Since ATP levels decrease immediately upon cell death, cellular ATP is a sensitive end point that is capable of measuring multiple logs of cell kill, whereas proliferation-type assays are sensitive to only approximately two logs of cell kill. See, e.g., Maehara et al., 1987, Eur. J. Cancer Clin. Oncol., 23:273. ATP is typically measured in this assay by bioluminescence using the luciferase (“firefly”) reaction.

Originally developed to evaluate cell lines, subsequent work mostly using ovarian cancer tumor samples indicated this might be a reliable assay to determine the action of chemotherapeutic agents. See, e.g., Kangas et al., 1984, Med Biol 62:338; Sevin et al., 1988, Gynecol. Oncol, Jl.:191-204. Improved methods for enzymatic dissociation of tumors, which do not affect drug sensitivity, and use of a serum-free culture medium, which facilitates selective growth of malignant cells in culture, are useful for success of this assay. See, e.g., Andreotti et al., 1995, Cancer Res., 55:5276-5282. A kit for practicing ATP-TCA-based assays is currently available from DCS Innovative Diagnostik Systeme Hamburg, Germany under the designation “TCA-100 Assay.”

The ATP-TCA assay has many desirable attributes. ATP bioluminescence technology can be used to measure both proliferating and non-proliferating malignant cells, in contrast to clonogenic and thymidine incorporation assays, which are only proliferation assays. ATP assay technology needs only small amounts of tumor material to measure multiple drugs and combinations over a range of concentrations. Further, multi-center studies with the ATP-TCA have demonstrated good evaluability with different tumor types, and the ability to use a variety of samples, including surgical or needle biopsies, ascites, and pleural effusions. In studies involving more than 2000 specimens, the ATP-TCA has been calibrated with good correlation of clinical outcome. See, e.g., Cree et al., Anti-Cancer Drugs, 8:541-548; Kurbacher et al., Amer. Soc. Clin. Oncol., 1384; 1998, Anti-Cancer Drugs, 9:51-57.

Currently, this assay is typically used as an Extreme Drug Resistance type assay (EDR) to measure resistance over a range of high to extreme test drug concentrations. EDR-type assays put great emphasis of the effects of drug at high concentrations, while ignoring activity at lower concentrations. These methods have relied upon selection of agents for which the area under a dose response curves (AUC) shows treatments which achieve greater than 90% inhibition at 100% or 200% of test drug concentrations (“TDC”). TDCs are determined by reference to pharmacokinetic data for individual drugs, and reflects likely tumor cell exposure levels from peak plasma concentration achieved using standard regimens incorporating the drug.

EDR-type assays, based on the ATP-TCA method, have been applied to a number of tumor types, but without consistent success. In ovarian carcinoma, the ATP-TCA assay has demonstrated good accuracy, reproducibility and success rate in determining resistance of dissociated cell from easily-obtained surgical samples. See, e.g., Andreotti et al. 1995, Cancer Research, 55:5276-5282. In a small study, an EDR-type ATP-TCA-based assay has been used to select chemotherapy for patients with heavily-pretreated, recurrent ovarian carcinoma, and an increased response rate, prolonged remission period and prolonged patient survival were achieved. See, e.g., Kurbacher et al., 1999, Amer. Soc. Clin. Oncol., 1384; Kurbacher et al., 1998, Anti-Cancer Drugs, 2:51-57 (therapy selected based on EDR-type criteria, namely agents with the highest AUC and greater than 90% ex vivo inhibitory activity at 100% TDC). Although primary ovarian carcinomas frequently respond to platinum-based chemotherapy, the majority of patients relapse, with further disease generally resistant to known salvage regimens. See, e.g., Cannistra, 1993, N. Eng. J. Med., 21:1550-1559). Another EDR-type ATP- TCA-based assay has produced suggestive results in selecting salvage regiments for patients who have relapsed. See e.g. Kurbacher et al., 1997, Clin. Cancer Res., 3:1527-1533 (salvage regimens selected based on EDR-type criteria).

In breast cancer, another common cancer, ATP-TCA assays of samples from surgical and needle biopsies have demonstrated good evaluability in testing single agents and combinations commonly used for breast cancer. See, e.g. Hunter et al., 1993, Eur. J. Surg. Oncol, 19:242-249 (assay calibrated using EDR-type criteria). Further, retrospective ATP-TCA assay results have correlated with clinical outcome, and have suggested generally effective further therapies. See, e.g. Cree et al., 1996, Anti-Cancer Drugs, 7:630-635 (selection based on EDR-type criteria, the best AUC and an inhibition greater than 90%). Although mitoxantrone is rarely used for breast cancer therapy, ATP-TCA assay data using breast cancer cells derived from 55 chemotherapy-naive patients at primary surgery indicates favorable in vitro response rates in comparison to doxorubicin, rates which have not yet been clinically confirmed. See, e.g. Abman et al., 1987, J. Clin. Oncol., 5:1928-1932; Kurbacher et al., 1996, Breast Cancer Research and Treatment, 41:161-170.

Another relatively common cancer, melanoma, usually has a poor prognosis, not greatly improved by known chemotherapy regimens. Analysis of ATP-TCA assay data from surgical specimens of cutaneous melanoma showed considerable heterogeneity of chemosensitivity, with the most active cytotoxic agents being cisplatin, treosulfan, paclitaxel, vinblastine, gemcitabine and mitoxantrone and combinations of these agents being the most active combinations. See, e.g., Cree et al., 1999, Anti-Cancer Drugs, 10:437-44. However, a further study, also for cutaneous melanoma, comparing the effects of the bifunctional alkylating agent treosulfan in vitro using an EDR-type assay based on the ATP-TCA method and in vivo in clinical trials revealed a considerable discrepancy. See, e.g. Neuber et al., 1999, Melanoma Res., 2:125-132. Uveal melanoma has been examined in vitro with the ATP-TCA assay, and was shown to have considerable heterogeneity of sensitivity to cytotoxic drugs, with considerable resistance to most agents, matching clinical experience. See, e.g. Myatt et al., 1997, Anti-Cancer Drugs, 8:756-762. In choroidal melanoma, ATP-TCA assay of surgical specimens showed sensitivity to a combination of treosulfan with gemcitabine or cytosine arabinoside far in excess of the best expected clinical expectations. See, e.g. Neale et al., 1999, Brit. J. Can., 79:1487-93; Chowdhury et al., Cancer Treat. Res. 25(5):259-70.

Current Tumor Assay Methods

Therefore, in the nearly 35 years of effort, after the first attempts of Black and Spears, significant problems have been encountered over and over, and still remain, using known methods for chemo-sensitivity testing of tumors. These included low evaluability rate, growth of non-malignant cells in test cultures, inability to obtain dose-response results for both single agents and combinations (particularly with small specimens), and the difficulties in obtaining reproducible, objective and quantitative-measurements. Even with the more reproducible and versatile ATP-TCA-based assays, efforts have focused on retrospective clinical correlations. Few prospective clinical studies to demonstrate efficacy and actual patient benefit have been performed. At best, they revealed important limitations to the clinical applicability of sensitivity assays of any type. At worst, none of these prospective studies were notably and unequivocally successful for such reasons as limitations of clinical and laboratory methodology, lack of systematic analytic efforts, flawed use of extreme drug response/resistance (EDR) type end-point criteria, and so forth.

In more detail, no known method addresses or recognizes errors inherent in EDR-type criteria, such as a clinical inability to combine drugs at high (more toxic) in vivo concentrations; response heterogeneity on combining “active” drugs (including sub-additive or antagonistic effects which the present invention is the first to recognize as being common) masked at high concentrations; false positives due to extreme dosage not actually attainable in the patient; false negatives due to failure to consider or assay for drug interaction (i.e. reversal of resistance or other forms of synergism); also failure to prioritize based on low versus high dose response; lack of strategic use of assay data, such as prioritization for sequential treatment; failure to recognize that high dose applications, the common understanding of current practice doctrine, may be a sub-optimum use of agents; and so forth. Further, empirical data resulting from EDR-type assays has typically resulted from isolated tests of individual drugs, and has not incorporated such key considerations as effects specific to particular diseases and their stages, translational (i.e. from laboratory ex vivo to overall clinical in vivo) success rates, prior history of therapy or resistance, dose response throughout the entire dose range, shape of the response curves of similar agents (i.e. those agents with similar structure or with dissimilar structure but similar mechanisms of cellular action).

Even more, there have been no, or very little, efforts directed to a systematic search for and classification of agent interactions, to ordering the treatment options by a strategic and systematic process incorporating considerations of subsequent therapy, of regimens limiting agent side effects or treatment cost, of creating opportunities for development of further treatments for a patient, and so forth.

Because of, inter alia, these heretofore unrecognized limitations and omissions, tumor chemo-sensitivity assays have not been accepted as a “standard of care” for cancer patients.

Citation, identification, or discussion of any material disclosed herein is not an admission that, and shall not be construed that, such material is available as prior art to the present invention. Further, citation or identification of any reference in this application is not an admission that, and shall not be construed that, such reference is available as prior art to the present invention.

### SUMMARY OF THE INVENTION

The present invention overcomes these limitations in the current state of the art, and establishes tumor chemo-sensitivity assays as a “standard of care” for cancer patients. The invention is based on important discoveries, notably that reliance on extreme drug resistance/response type assays touches only the tip of the therapeutic iceberg, and even where relevant, is often clinically misleading. Once agent response is examined throughout the dose range, and in particular at doses low compared to the therapeutic drug concentration (TDC), further discoveries of a plethora of once hidden treatment possibilities rapidly emerge. For example, the reproducible and systematic methods of the present invention readily discover and determine new regimens using “standard” drugs in new sequences and combinations shown to be useful in particular patients and in selected groups of patients, determine patients and groups for which first-choice active drugs fail, and offer new possibilities to patients with so-called “resistant” tumors. Furthermore, the methods of the present invention incorporate multi-factorial considerations and information that leads to flexible mathematical treatment for determining “best” overall regimens.

One embodiment of the invention is directed to methods and systems that allow physicians (and other users) to select chemotherapeutic treatment protocols for oncology patients, including the selection of an agent or combination of agents and selection of multiple agents or combinations suitable for sequential treatment. These methods and systems provide for selection of a therapeutically effective agent or drug (or combinations of agents or drugs), selected using an in vitro assay evaluating one or more agents or a combination of agents, at low and high dosage, preferably at low dosage for activity against the specific tumor present in the patient. Advantageously, the present invention allows selection or use of agents or combinations that, although nonstandard or otherwise thought to be ineffective (such as those which failed clinical trials), are actually effective in a particular patient or patient population not previously appreciated. The invention also provides for the selection of new agents or combinations for Phase III trial development as treatments of choice for patients with tumors of defined histology, or pathology, or history of prior treatment.

Preferably, the results of this assay are evaluated with respect to the results of similar assays of other patients having clinically similar tumors and with respect to the overall clinical response of the assayed agents and combinations. This evaluation permits identifying agents and combinations which, because of their advantageous standing in range of similar assays in other patients, have increased chances of therapeutic success. Thereby, in addition to increasing the chances that treatment will produce tumor regression or lengthy growth inhibition and delay disease complications, patients benefit from better safety profiles, lower toxicities, more practical and more easily tolerated delivery of drug(s) as well as better cost effectiveness compared to present empirical methods. Patient benefits further include the capability of selecting a strategic plan that optimizes the distribution of available agents over sequential treatments, the ability to avoid simultaneous use of agents which may have conflicts or negative interactions, the opportunity to effectively use agents (such as, e.g., synergistic combinations), which would be less effective when used in standard fashion (due to, e.g., antagonism or frequent ineffectiveness), and such similar situations as may be envisioned by those skilled in the art.

Another embodiment of the invention is directed to methods and systems that allow physicians to devise treatment protocols for patients with both initial and salvage drug options known at time of initial treatment. Rather than first using a priori agents, known to be best agents in a single combination regimen, specifically individualized best agents and combinations can be selected and used in sequence, and additional agents with favorable therapeutic profiles can be recruited. Unlike current practice, this invention sequence does not produce patient effect through dose intensification, but, instead, is designed to advantageously use new combinations of agents with proven, greater than additive, known herein as synergistic, activity, preferably at lower doses. Therefore, through this invention the patient experiences better end results than with dose intensification, because equal effect is achieved at lower doses with fewer consequent side effects and toxicities.

Another embodiment of the invention is directed to examination of the therapeutic agents or combinations from a “strategic patient perspective” so that the drugs can be utilized effectively over the course of a patient's illness, avoiding limiting toxicities, avoiding sub-optimum standard applications, while effectively utilizing agents which would be ineffective if they were used in standard empirical practice. The ineffectiveness of a particular agent is circumvented by novel partnering with other agents or by selection of a treatment sequence which may produce collateral sensitivity to a drug combination reserved for salvage application. These circumventions are uncovered through the ex vivo assays of such combinations and analysis of tumor responses according to the present invention.

Another embodiment of the invention is directed to systems and methods to allow health care providers to devise protocols to prioritize or order single drugs or drug combinations for oncology patients taking into account potential heretofore unsuspected interactions between the drugs or identify tumors ideally suited to known drug synergies. This gives patients the benefits of treatment protocols with the ability to avoid, overcome or reverse drug resistance and antagonism.

Embodiments of the invention are based, inter alia, on the features and discoveries, which have not been heretofore appreciated. A first feature and discovery is that resistance and antagonism for agents, even for agents ideally active in the tumors to which they are targeted, is surprisingly common, affecting many agents targeted against many tumor types. Although previously thought to be rare, the present invention has surprisingly discovered that resistance and antagonism may affect up to half the intended empirical applications of agent/tumor combinations. Second, agent synergism, including reversal of resistance, is also common, common enough to warrant systematic testing. In fact, this discovery indicates that whole classes of now neglected agents that had not been found to be useful may, in fact, be useful in synergistic combinations and should be tested again ex vivo in new combinations. Third, although current practice is to focus on high and even extreme concentrations of agents, this invention teaches that great clinical utility is present also in the low concentration ranges, especially when agents are tested in combination.

To capture the benefit of these features and discoveries, it is advantageous to process assay sensitivity/resistance data by using systematic, repeatable and mathematically based methods. This the invention does by introducing the concepts of a therapeutic index and of a database of classified tumor response assay data. Basically, the database includes tumor response data classified by, at least, tumor type and anatomic origin. The therapeutic index, then, depends in an increasing manner (preferably directly) on clinical translation experience (for example, the observed response rate) and in a decreasing manner (preferably, inversely) on how individual patient tumor assay data compares with the database of response data (the more responsive the comparable data, the lower the resulting index).

The methods and systems of the present invention are useful to devise cancer treatment protocols not only for individual cancer patients but also for groups of cancer patients suffering from a particular class or type of cancer as well as for designing clinical trials to evaluate potential anti-cancer agents and identify new and useful anti-cancer agents and protocols for the use of such agents for cancer treatment. In this use, multiple samples of a single tumor type from multiple patients are assayed ex vivo and the results analyzed according to the invention to select agents, combinations and protocols, which, for example, are active on average for the tumor type or compare favorably to combinations used in standard practice based on the frequency of tumor inhibition, or other clinical benefits defined in the methods of the present invention.

With the information provided by the present methods and systems, a physician can avoid administering toxic and costly drugs shown by the present invention to be specifically ineffective in the current patient. In addition, the risk that a patient's tumor will acquire drug resistance is ameliorated by utilizing a sequence of agents and combinations of different pharmacological types that are specifically active in the instant patient. The physician can choose between alternative standard chemotherapy regimens, eliminating regimens that contain inactive drugs and in an innovative manner avoiding sub-additive, or antagonistic, use of agents which are individually more active or would be more active in other combinations. To the extent an ineffective chemotherapy drug can be avoided, the patient can receive alternative standard treatments containing optimal doses of potentially effective drugs. This is particularly helpful in responsive diseases such as breast cancer, for which there are many standard treatment options with, heretofore, virtually no methodical and systematic method for choosing among the possibilities for a particular patient. Such benefits are available for many other cancers than breast cancer, and even for diseases not conventionally responsive.

With the present invention, the physician can evaluate additional chemotherapeutic options for patients who have failed initial chemotherapy. Use of the invention with samples of recurrent tumor from a patient may reveal previously unexpected agents or combinations to which the tumor is now sensitive, an example of possible collateral or induced sensitivity. On the other hand, the oncologist may consider, in conjunction with a patient's preferences and medical history, whether a patient whose tumor is now substantially or largely resistant to all conventional chemotherapy agents and combinations, should continue to receive less effective chemotherapy, be provided with supportive care or be referred to a research protocol testing entirely new agents. Further, the entirely new agents can be assayed and if the tumor is resistant even to these, the patient can be spared unnecessary toxicity. Alternatively, the present invention can be utilized to assist the selection of best candidates from among Phase I research agents, thereby providing enhanced triage and improved efficiencies in agent development efforts.

Accordingly, the present invention provides a fast track for compassionate or initial release of investigational drugs and speed their targeting and use in combination therapy. Many more patients will be encouraged to participate in clinical trials because the assay selection process will increase the chance that the drugs will benefit each individual in the trial.

Identification of an appropriate option for the treatment of a tumor of rare or unknown primary site is also possible even in the complete absence of guidance from the literature. Additionally, an oncologist may select the most effective drug or drug combination for “strategic” optimum use as described above and can develop empirical or sequential treatment protocols for rare or other tumors for which protocols have not been developed.

The present invention adopts a more productive approach to the selection of agents and combinations for chemotherapy of cancer. In addition to searching for the “best” for a particular-type of cancer in one patient or in a group of similar patients, this invention recognizes the chronic nature of this disease and searches for multiple effective treatments based on multiple combinations of agents. This invention generates multiple treatment options and sequences so that both current and long term treatments can effectively aid the patient. In other words, good combinations are uncovered that can be saved for later administration after other combinations of, preferably, different classes of agents. This contrasts to current practice of escalating doses of the same agents and combinations and thereby precipitating increased toxicity. To use combinations, this invention seeks activity at lower, less toxic doses. Lower doses are made possible by searching for synergistic agent interactions among drugs. While recognizing that degrees of drug antagonism are more common than previously expected, synergies are shown to exist. The present invention can discover such synergies for a particular patient's cancer and can exploit them in long term treatments.

Another embodiment of the invention includes novel methods for devising oncology treatment protocols for treatment of cancer patients. In another embodiment, the present invention includes systems with which a user can input and access the necessary data and perform these methods to select treatment protocols. In a further embodiment, the present invention also provides software codes and computer-readable storage media having fixed therein a sequence of instructions generated by these codes and that when executed by a computer direct performance of steps comprising the novel data processing system or methods and algorithms of the invention.

The methods, systems and software of the present invention allow physicians and others to devise treatment protocols for patients with both initial and salvage drug options known at time of initial treatment and to examine the therapeutic agents or drugs from a “strategic perspective” so that the drugs can be utilized effectively over the course of a patient's illness, avoiding limiting toxicities, avoiding sub-optimum standard applications, and effectively utilizing drug(s) which would be ineffective if they were used in standard empirical practice.

More generally, the present methods and systems can be used in the applications set forth above (as well as others that will be apparent to one of skill in the art), including but not limited to methods for devising treatment protocols for cancer patients, methods for devising protocols for both ex vivo and clinical trials for drug discovery and/or development, etc. The treatment protocols can advantageously take into consideration factors including targeting improved quality of life, cost and side effect containment, etc., as well as experimental laboratory assay results and clinical information. In addition, the present invention provides a novel method for operating a laboratory service using the novel data processing systems and methods and algorithms and/or computer software products. The invention provides for the adjustment and modification of agent selection methods to reflect differing priorities of potential users, such as individual physicians, third party payers, corporate drug development, academic departments, and so forth. Users of the present invention from all these (and other) backgrounds can compare the risks and benefits of potential therapies.

In more detail, the methods and systems of the present invention perform novel analyses and evaluations of data obtained from chemo-sensitivity/resistance assay(s). Importantly, to select particular agents or combinations for a particular patient, the novel methods evaluate three types of data: (i) in vitro or ex vivo sensitivity/resistance assay data for a particular tumor of the patient when exposed to a plurality of agents and/or combinations; (ii) reference sensitivity/resistance assay data for a plurality of tumors from the plurality of other prior, or reference, patients when exposed to the plurality of agents or combinations, and (iii) the clinical experiences, or clinical response rates, with the plurality of agents or combinations assayed.

Generally, a particular agent or combination for the patient is given a high rank by the present invention if the patients assay results for this agent or combination are similar to the assay results for those reference patients that, according to clinical data, are likely to have responded to this agent or combination. To a first approximation, additionally those reference patients that are clinically likely to have responded are those patients with the best assay data. For example, if an agent is known to have a 30% clinical response rate measured against some standard, then those reference patients having the best 30% assay data are those that are likely to have responded. The assigned rank also takes into account the clinical response rate. An agent or combination, for which the particular patient's assay data is similar to the best responders to that agent, will be ranked higher according to the clinical response rate. For example, agents or combinations that produce the highest clinical (or empirical) response rates are advantageously given the most initial rank (or weight) in the selection method, while agents or combinations which, though they produce ex vivo inhibition similar to such clinically-best agents or combinations, are lower ranked initially if their clinical response rates are lower.

Because of the heterogeneity of biological responses in view of the above, the methods of present invention assign a rank for a particular agent or combination in a particular tumor of a patient which is depends in an increasing manner (preferably, directly) on the a priori known clinical response rate of this agent or combination, and depends in a decreasing manner (preferably inversely) on the ranking of the particular patient's assay data among the assay data obtained from a plurality of reference patients. If such reference response data is not available, the methods simply assign a nominal rank to an agent or combination. For example, an agent or combination can be assigned a nominal 20% response rate (the Phase II cutoff), or a combination can be assigned the formulaic sum of the response rates of its components, if that is higher.

It is further preferable that, when the present invention is used to devise cancer therapy protocols for cancer patients, the methods and systems use not only data obtained from in vitro or ex vivo tumor chemo-sensitivity/resistant assays, e.g., ATP-TCA assay(s), but also can incorporate information relating to factors including: expected side effects, expected toxicity costs, expected monetary costs of drug(s), and whether or not a salvage drug option can be identified or constructed, e.g. by re-ordering the sequence in which a pair of agents is administered or by rearranging the combination of agents administered, etc. Further important factors include the demonstration of agent synergisms, including the use of an agent thought to be ineffective as a component of a synergistic combination. These factors are used to adjust, either up or down, or confirm the initial ranking of an agent or combination determined from assay data.

According to the invention, those agents or combinations with substantially the best rankings are selected and considered in forming a strategic treatment protocol for a particular patient or a class of closely similar patients. Rankings are substantially similar if, for example, they are preferably within a 20% range of each other, or less preferably within a 30%, range, taking into account statistical considerations which define a probability range of responses, and depend on, for example, uncertainties present in assay data and in the other information relied upon. A best therapeutic index is one which most preferably indicates that an agent or combination is within the most responsive 10% of assayed agents or combinations, or within the most responsive 20%, or more preferably within the most responsive 25%, or within the most responsive 30%, or within the most responsive 40% or preferably within the most responsive 50% or higher.

As used in this invention, the “best” reference assay data and the data most “similar” to the data of a particular patient are determined by numerical measures which give highest weight to responses to agents or combinations of agents at lower doses, e.g., at 2%, 5%, 6.25%,10%, 12.5%, 15%, 20% 25%, 30%, 35%, 40%, 45% or 50% of the test drug concentration (TDC) in the assay(s), or demonstrate inhibition equivalent to a reference response curve assigned lowest rank. The novel methods take into account not only sensitivity of a tumor to a particular agent but also resistance or sensitivity of the tumor to other individual agents or combinations of agents and provide, to the extent possible, an option of a salvage drug regimen. Preferred numerical measures include the area under the graphical curve-representation of the tumor response data from, e.g., 6.25% to 50% TDC, or from 12.5% to 25% TDC, or other range with data (e.g. 2%-30%, 10%-50%, 15%-40%, 20%-60%) that is preferably entirely less than 100% TDC.

The following terms are used in the following description with the following meanings. As would be understood by those skilled in the art, a “salvage” drug is a therapeutic agent or combination of agents that can be used effectively for treatment in a situation in which, following initial or repeat cancer chemotherapy, a patient has a relapse or recurrence of cancer.

As used in the present specification, the “agents” which are evaluated for tumor inhibitory activity in the in vitro or ex vivo chemo-sensitivity/resistance assays as potential cancer therapeutics are intended to encompass any agents, which either alone or in combination with another substance, demonstrate tumor inhibitory activity. Accordingly, the “agents” include any substance which, whether alone or in combination with another substance, is tumor cell cytostatic or cytotoxic. Hence, the agents include but are not limited to known anti-cancer drugs, untested potential anti-cancer drugs, compounds having anti-angiogenic, anti-oncogene, anti-growth factor or receptor or membrane perturbing activity as well as other compounds such as aptamers, siRNAs, cytokines, hormones, enzymes, and the like, which when administered to a patient with another agent are tumor cell cytostatic or cytotoxic although they may not have such activity when administered alone.

As used herein, the term, “expected side effect” is intended to mean the published. incidence of WHO or NCI toxicities for a given regimen, with particular emphasis on those side effects of any grade considered “limiting”, compromising the safety of further or future therapy. For example, a leukemia risk is unacceptable in adjuvant therapy; neuropathy is relatively unacceptable if one wishes to use a potential neurotoxin as a salvage option; high dosage marrow suppression is unacceptable if a severe bone marrow toxin, e.g., topotecan/CBCDA is the basis of a salvage regimen option. In certain embodiments, the expected side effects encompass grade 3 or 4 toxicities.

As used herein, the term “expected toxicity costs” is intended to mean those costs, monetary and/or otherwise, resulting from toxic side effects including those which interfere with, limit or prevent a patient from performing normal daily activities, including such as work, caring for self or others.

In the embodiment in which clinical treatment for cancer patients is being devised, the drugs or drug combinations, including protocols in which any “drug combinations” can be tested simultaneously or sequentially, the drugs being assessed will often (but not necessarily) already have regulatory approval and be commercially available. Therefore, the expected toxicity side effects, toxicity costs and monetary costs will be either readily available from the literature or readily determinable from the literature and/or historical clinical records. To resolve any “conflicts” in the literature, preference is given to toxicity assessments published as part of randomized trials or Phase II clinical trials performed in a multi-institutional prospective format; less weight is given to initial Phase I clinical trials or single institution reports.

As used herein, the clinical “response rate” is the response of a group of patients with clinically similar cancers to an agent or combination are measured in clinical trials. For example, without limitation, these response rates can be determined in Phase II or III trials performed in order to obtain Federal Drug Administration (FDA) approval. The nature of the response, e.g., remission, regression, relief of symptoms, or so forth, is selected as appropriate for the clinical setting, e.g., primary or recurrent tumor. Where no response rate measure is available, the present invention conservatively assumes a nominal 10% or 20% response rate, which is the minimum for FDA Phase II “approval”.

As used herein, “TDC” is determined for each agent or combination of agents based upon the known pharmacokinetic data for such agent or combination and is calculated to reflect tumor cell exposure level resulting from a standard regimen incorporating such agent or combination of agents. As used herein, “100% TDC” is the concentration at the tumor cell level based upon the peak plasma concentrations achieved in clinical practice. As would be understood by those skilled in the art, the other tested “TDC concentrations” represent serial dilutions of such dose level. In certain embodiments, e.g. when the complete and partial response rate of the single drug is known empirically or can be derived from prior clinical trials, the TDC is reset as needed so that the percent of specimens in the ≧50% inhibition at 12.5% TDC will correspond to the clinical complete response (CR) rate and the ≧50% inhibition at 50% TDC will correspond to the partial response (PR) or PR+SD rate (best fit) with any error.

TDCs for new agents without clinical experience are developed empirically using a panel of tumors, either a broad panel including the tumors commonly targeted in Phase II trials (e.g., colon, lung, breast) or a narrow tumor-specific panel if the agents are designed to target a narrow range of tumors. The assay information is used to set the TDC concentrations so that 20% of the tumors assayed are inhibited by 50% or more between 25-50% of the determined TDC. These assays include the use of cell lines and nude mouse xenografts. TDCs for new agents, to a first approximation, reflect molar concentrations proportionate to those found for other drugs of the same class. The TDC for cell lines will need to reflect the far greater sensitivity (error) of cell lines. The TDC can be used for xenografts or lyophilized live frozen tumors over a limited number of passes. As part of this invention selected tumors will be stored in xenograft and early passage tumors lyophilized for confirmatory testing of surprising findings.

As used herein, generally, drugs are agents. However, agents may not yet be drugs, if drugs are limited to agents approved for or used in patients. Agents, therefore, can specifically include test compounds and other cytotoxic influences.

Also as used herein, a treatment regiment is clinically effective if it achieves a selected range of probability of response of clinical success. The meaning of response and clinical success will vary according to the clinical setting. For example, it can range from eradication of clinically apparent cancer, to stabilization of or reduction in tumor load, or to providing enhance terminal quality of life if other measures have failed. Approximate or substantially approximate concentrations, for example as a percent of TDC, are understood in the several methods described above (and as can be modified by those experienced in the art) to be as specified within known error limits for establishing a TDC value and for determining actual agent concentrations.

Clinical Progress can be Classified According to the Known Methods Using Tumor-Node-Metastasis Information.

In detail, in a first embodiment, the present invention includes a method of ranking one or more candidate chemotherapeutic agents or one or more candidate combinations of chemotherapeutic agents for a particular tumor from a patient comprising: providing both a plurality of sensitivity/resistance assay reference data for a plurality of reference tumors from a plurality of reference patients when each tumor is exposed to one or more of a plurality of reference agents or reference combinations, and also a plurality of clinical response rates experienced with the reference agents and the reference combinations, providing actual sensitivity/resistance assay data for the particular tumor of the patient when exposed to one or more candidate agents or one or more candidate combinations of agents, determining initial therapeutic indexes for the candidate agents or the candidate combinations, wherein the initial therapeutic indexes depend on (i) the actual sensitivity/resistance assay data for the particular tumor patient, (ii) the plurality of sensitivity/resistance assay reference data, and (iii) the plurality of clinical experiences. Final determination of therapeutic indexes for the candidate agents or the candidate combinations are determined by adjusting the initial therapeutic index in accordance with rules representing ex vivo and clinical goals and expectations for the candidate agents and the candidate combinations.

In aspects of the first embodiment, wherein a high therapeutic index signifies a more desirable candidate agent or candidate combination, adjusting the initial therapeutic indexes includes increasing the initial therapeutic index of an agent or combination if strategic uses of the agent or the agents of the combination are identified. In particular, the strategic uses identified include use of an otherwise inactive agent in an active combination, or salvage of an agent, or use of agents of an effective combination in different effective combinations. Salvage of an agent includes effective use of the agent where previous uses were as part of an ineffective or antagonistic combination.

In a second embodiment, the present invention includes a method of selecting one or more chemotherapeutic agents or combinations of chemotherapeutic agents likely to be effective against a tumor from a particular patient comprising: determining final therapeutic indexes for a plurality of candidate agents or candidate combinations of agents by performing the methods of the other embodiments, and selecting those candidate agents or combinations with the best final therapeutic indexes.

In a third embodiment, the present invention includes a method of operating a laboratory service to formulate cancer therapy protocols comprising: determining final therapeutic indexes for a plurality of candidate agents or candidate combinations of agents by performing the methods of the other embodiments for a patient or a group of patients, and formulating a clinical treatment protocol for the patient or the groups of patients depending both on the final therapeutic indexes of the candidate agents or candidate combinations and also on the ability, if any, to use a candidate agent or combination in a salvage regimen.

In a fourth embodiment, the present invention includes a method of treating a particular tumor in a patient comprising: determining final therapeutic indexes for a plurality of candidate agents or candidate combinations of agents by performing the methods of the other embodiments, and selecting one or more candidate agents or candidate combinations with the best final therapeutic indexes, and treating the patient with a protocol including the selected agents or combinations.

In a fifth embodiment, the present invention includes a method of determining the effectiveness of a selected agent or a selected combination of agents for a particular type of tumor comprising: determining a plurality of final therapeutic indexes for the selected agent or selected combination of agents by repetitively performing the methods of the other embodiments for a plurality of tumors of the particular type from a plurality of patients, and determining the selected agent or selected combination as effective if the determined final therapeutic ranks for the selected agent or selected combination indicate that the agent or combination are effective against the particular tumor type.

In a sixth embodiment, the present invention includes a programmed computer for ranking one or more chemotherapeutic agents or combinations of chemotherapeutic agents for a particular tumor from a patient comprising: at least one processor and processor-accessible memory, and input/output devices for inputting to the computer and for outputting from the computer, (i) wherein the computer has access to one or more databases having a plurality of sensitivity/resistance assay data for a plurality of reference tumors from a plurality of reference patients when each tumor is exposed to one or more of a plurality of reference agents or reference combinations, and also to a plurality of clinical experiences with each of the pluralities of reference agents or reference combinations, and (ii) wherein instructions loaded in the memory of the computer cause the processor to perform a method with the following steps: inputting providing actual sensitivity/resistance assay data for the particular tumor of the patient when exposed to one or more candidate agents or one or more candidate combinations of agents, accessing the database to retrieve both a plurality of the sensitivity/resistance assay reference data, and the plurality of clinical experiences, and determining initial therapeutic indexes for the candidate agents or the candidate, wherein the initial therapeutic indexes depend on (i) the actual sensitivity/resistance assay data for the particular patient, (ii) the sensitivity/resistance assay reference data, and (iii) the plurality of clinical experiences, determining final therapeutic indexes for the candidate agents or the candidate combinations by adjusting the initial therapeutic index in accordance with rules representing clinical goals and expectations for the candidate agents and the candidate combinations, and outputting the determined final indexes.

In a seventh embodiment, the present invention includes a system for ranking one or more chemotherapeutic agents or combinations of chemotherapeutic agents for a particular tumor from a patient comprising: at least one programmed computer of the other embodiments, and one or more databases having a plurality of sensitivity/resistance assay data for a plurality of reference tumors from a plurality of reference patients when each tumor is exposed to one or more of a plurality of reference agents or reference combinations, and also to a plurality of clinical experiences with each of the pluralities of reference agents or reference combinations.

In an eighth embodiment, the present invention includes a computer readable medium comprising encoded computer instructions for causing a computer to function according to the methods of the other embodiments of the invention.

In a ninth embodiment, the present invention includes a computer-accessible database for providing reference data for the methods of the other embodiments comprising a computer-readable memory configured with (i) a plurality of sensitivity/resistance assay reference data for a plurality of reference tumors from a plurality of reference patients when each tumor is exposed to one or more of a plurality of reference agents or reference combinations, and (ii) a plurality of clinical response rates experienced with the reference agents and the reference combinations.

In a tenth embodiment, the present invention includes a method of screening one or more candidate chemotherapeutic agents or one or more candidate combinations of chemotherapeutic agents for effectiveness patient comprising: providing both a plurality of sensitivity/resistance assay reference data for a plurality of reference agents or reference combinations, and also a plurality of clinical experiences for the reference agents and the reference combinations, providing actual sensitivity/resistance assay data for the particular tumor of the patient when exposed to one or more candidate agents or one or more candidate combinations of agents, and determining final therapeutic indexes for the candidate agents or the candidate combinations by final therapeutic indexes depend on (i) the actual sensitivity/resistance assay data, (ii) the sensitivity/resistance assay reference data, the plurality of clinical experiences for the reference agents, and (iv) clinical goals and expectations for the candidate agents and the candidate combinations, wherein the effectiveness is represented by the final therapeutic indexes.

Other embodiments and advantages of the invention are set forth in part in the description, which follows, and in part, may be obvious from this description, or may be learned from the practice of the invention.

### DESCRIPTION OF THE DRAWINGS

The present invention may be understood more fully by reference to the following detailed description of the preferred embodiment of the present invention, illustrative examples of specific embodiments of the invention and the appended figures in which:

FIG. 1 illustrates schematically a preferred computer system implementing the present invention.

FIG. 2 illustrates a preferred implementation of the general methods of the present invention.

FIG. 3 illustrates exemplary tumor response data presented in a graphical format.

FIGS. 4A-C graphically illustrates representative tumor response data used in the present invention.

FIG. 5 illustrates exemplary general adjustments of the final therapeutic index.

### DESCRIPTION OF THE INVENTION

The present invention provides novel methods for selecting chemotherapeutic agents, or combinations of agents (simply “agents” or “combinations”), for a particular cancer afflicting a particular patient. Preferably the agents or combinations comprise a plurality, which may be a plurality of different agents suspected to be effective against the same or a different disorder, or a plurality of agents suspected to be effective against the same disorder, but heretofore, not appreciated as providing a synergistic effect. A preferred plurality comprises 2 agents, 3 agents or 4 agents, which may be tested individually or as combinations. More preferred are 4 agents, 5 agents or 6 agents, again individually or in combinations. However, as is appreciated by those skilled in the art, the methods and systems of the invention allow for the testing of even higher numbers of agents or combinations of agents with relative ease, as compared to conventional testing modalities.

The selection methods use data from assays of the sensitivity/resistance (simply “assays”) of the cells both of the particular patient's cancer and also of the cells of prior similar cancers which afflicted previous similar patients. The former data is referred to as “actual” data, while the latter data is referred to a “reference” data. The invention further provides computer systems that include methods and programs implementing the selection methods of the present invention. The methods and systems of the present invention have numerous clinical applications, notable applications being to treating individual patients and to assays and analysis which can make pilot studies and phase I and II trials more focused and effective. Methods of this invention can also assist in the interpretation of the results of Phase I, II or III trials and provide insights for further efficient development of both standard and novel agents and combinations thereof.

Merely for ease of explanation, the detailed description of the invention is divided into sections describing, first, preferred systems methods and preferred computer methods, next, preferred assays, and, finally, exemplary applications of these methods and systems.

Methods and Computer Systems

In the following the methods of the present invention are described, without limitation, principally with respect to their implementation as programs and methods for computer systems. However, it will be apparent to one of skill in the art, that practice of these methods is not limited to computer system implementations. Where the amount of data and manipulations permit, these methods can also be directly practiced without the assistance of computer systems. Accordingly, it is to be understood that the present invention includes any implementation whatsoever of the general methods of selecting agents or combinations for particular patients in all the applications disclosed herein.

Further, in the following, illustrations of the methods and systems of the invention are primarily with respect to agents and combinations of two agents. This is for convenience only, since the invention is capable of evaluating combinations of three, four or more agents. Especially since the invention preferably examines activity at low dose ranges, such larger combinations are possible without excessive toxicity.

Systems of the Invention

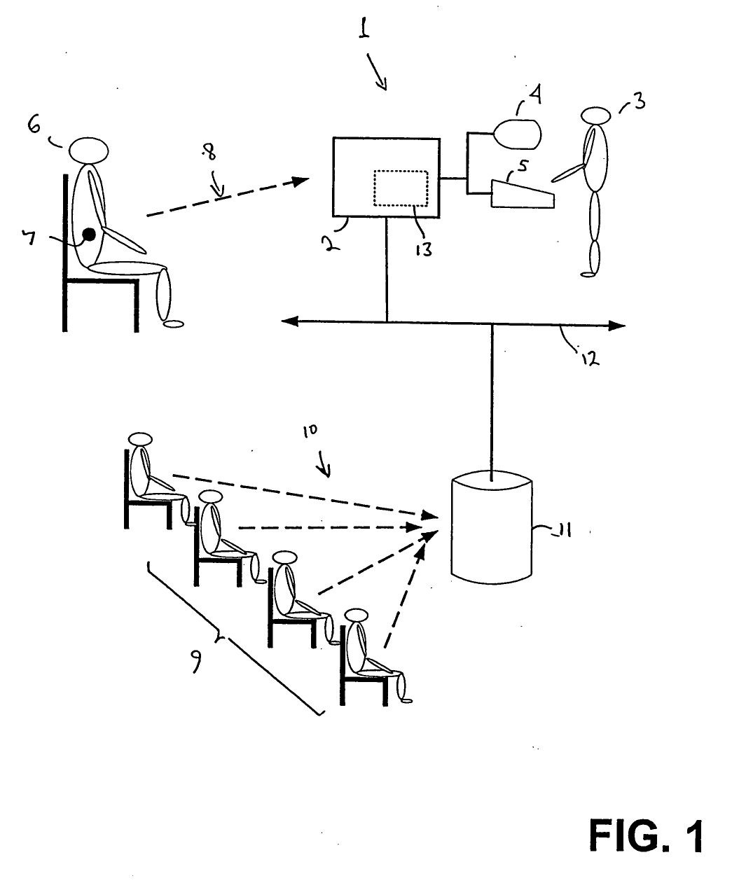

FIG. 1 generally illustrates aspects of the systems of the current invention; namely, in response to user 3, the invention processes actual assay data from tumor 7 present in patient 6 in view of further assay reference data from a plurality of reference patients 9 in order to help the user select chemotherapeutic agents for patient 6. Although, as set forth above, the present invention has numerous other application, in the following and without limitation, the description is primarily in terms of selecting agents or combinations for a particular patient.

In more detail, computer system 1, implementing the methods of the present invention, includes computer 2, which can be a standard personal computer, for example, based on an Intel or other microprocessor, including standard memory, disk and/or optical storage, input/output facilities, network/communications interfaces, and so forth. Alternatively, computer 2 can be an equivalent or more capable workstation or other computer. In FIG. 1, physician user 3 (or other qualified health professional user) is in the process of selecting therapeutic agents or combinations for treating tumor 7 of the physician's patient 6. In so doing, using input devices 5 of computer system 1, which can include keyboard, mouse or other pointing device, voice input unit, and so forth, the user inputs commands and data, which, as represented by arrow 8, includes at least sensitivity/resistance assay data, resulting from exposure of the cells of the patient's particular tumor 7 to various agents and combinations. Alternatively, arrow 8 can represent the automatic input of this assay data, as is possible when computer system 1 is directly interfaced to the laboratory equipment that gathers this assay data. Results produced by the methods of the present invention are output to the user by means of output devices 4, which can include monitor, printer, and so forth.

Importantly, these methods evaluate the assay data input in a framework provided by similar assay reference data previously gathered from ex vivo assays of tumors from a number of reference patients (or, possibly, in vitro, reference assay systems). These reference patients can be patients of physician-user 3, or alternatively, can be patients of other physicians of provider institutions who share their assay data. This framework data is illustrated as gathered from reference patients 9 (the present invention not being limited to four, or to any particular number of reference patients) and input 10 for storage in database 11. Computer system 1 and database 11 and can have many physical relationships implemented and represented by interconnect 12, which links the database with computer system. For example, database 11 can be part of the computer system; in another alternative, the database and the computer can be collocated but distinct; in a further alternative, they can be physically remote from each other; or in yet a further alternative, database 11 can be distributed across numerous computer systems, perhaps including computer system 1, all of which communicate to share assay data of the reference patients. In various embodiments, such communication can be limited by the proprietary or confidential aspects of certain data and results. One of skill in the art will immediately understand that the present invention comprehends these and other modes of data and function distribution known in the art.

Further, the present invention includes databases, such as database 11, which are computer-readable memories configured with data for the practice of the methods of the present invention. These databases can include main, or dynamic, memory that is directly accessible to a processor and configured with such data; they can also include secondary storage configured with such data; they can also include removable media, such as optical or magnetic disks, so configured. Further the memories so configured need not be physically collocated, but can include distributed memories that are preferably interconnected with means for data retrieval from all the distributed instances.

Finally, the methods of the invention are implemented by the computer instructions of program 13 which have been loaded in the memory of computer 2. This program and its computer instruction can be introduced into computer 2 and then loaded into the memory in any convenient manner, for example, by being read from removable optical or magnetic storage media on which it is recorded, or by being transmitted over network connections, or so forth. The program instructions reside in the permanent storage of computer 2 until needed, whereupon they are loaded in dynamic memory accessible to the processor and cause the processor (or microprocessor) to perform the methods of the present invention.

Output recommendations from the methods of the present invention can take several forms including, but limited to, the following: a numeric score; a numeric ranking; a recommendation formatted as a language (for example, as English). The output can include, for example, a summary of the decision points which most strongly determine outcome, or initial scores outcome and scores after each of one or more adjustments described with respect to Table 4. Further, the computer system can include capabilities to (temporarily) redefine the reference group or to seek expert assistance on selecting a best reference data group through consultation or viewing the practice clinical correlation translation scores of prior users. Additionally, the computer instructions of program 13 can be modified it will be understood by those experienced in the art in uses friendly fashion to prioritize selected aspects/decision points of the algorithm.

Further, the data base of the present invention may be divided or include classifications that identify national or ethnic origin of the assay data. The system of the present invention also includes help programs as are known in the art and (expert) interfaces to assist in quality control of the results produced. The system can be multi-user of single user.

Finally, the computer systems of the present invention are configured with such security as is known in the art to be necessary to protect the privacy of individuals, either users or those about whom data is stored, and to meet applicable regulatory requirements. The security can be configured as appropriate for research uses, for consultation uses, for routine treatment uses, and so forth.

Methods of the Invention

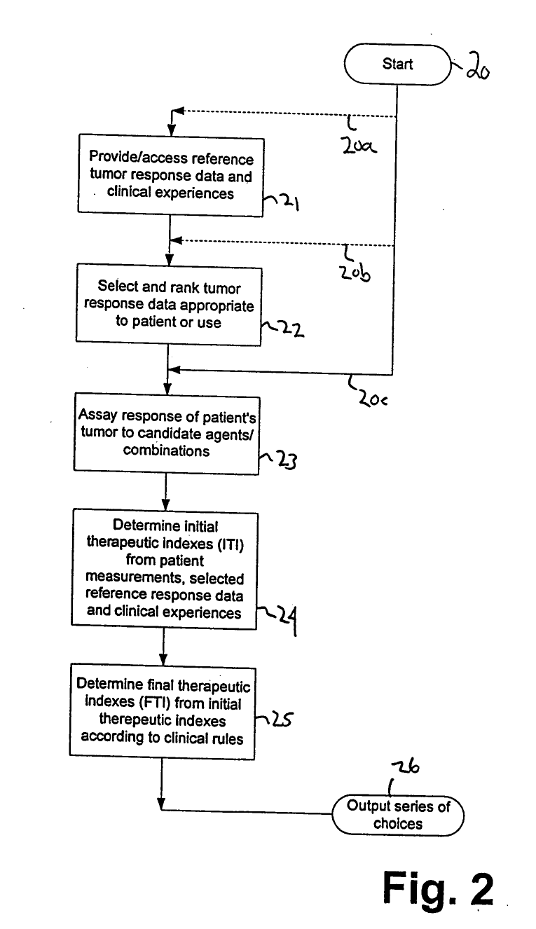

FIG. 2 broadly illustrates the preferred implementation of the methods of the present invention. These methods generally start at step 20, but in detail and depending on prior use of this invention in connection with a particular patient, the actual starting step can be reached via branches 20a, 20b or 20c. In the most general case of branch 20a, the methods start completely anew and obtain access to the necessary reference tumor response data (simply “TRD”; tumor response curves are simply “TRC”). In the case of branch 20b, the methods have some previous acquaintance with this patient, and need only to select reference tumor response data relevant and appropriate to the particular of this patient. Finally, in the case of branch 20c, such relevant reference data has already been selected, and the methods can begin to process tumor response assays from the particular patient of interest.

Turning to the most general case, at step 21, the methods preferably obtain access to, or less preferably actually provide by performing the necessary assays, reference tumor response data and associated clinical translation experience data, for example, clinical response rates for a variety of agents or combinations. The tumor response data is initially obtained by conducting in vitro (or ex vivo) chemo-sensitivity/resistance assays of a broad selection of tumor types from a diversity of patients when exposed to a broad range of chemotherapeutic agents. The types of tumor tissues assayed are generally classified according to categories found to be useful in pathological and clinical practice, such classifications are known to one of skill in the art. For example, a preferred classification identifies tumor types by the anatomic origin and the histological type of proliferating cell, such as ductal carcinoma of breast, squamous cell carcinoma of lung, adenocarcinoma of colon or prostrate, and so forth. Generally, the anatomic origin refers to the organ of origination, such as the breast, the lung, the colon, the skin, and so forth. For certain cancers, primarily lymphoma and squamous cell carcinoma of the skin, the exact anatomic origin is of less importance, and for others, such as an undifferentiated cancer, it may not be known. In addition similar anatomic origin can refer not only to anatomic origin in the patient, but also to similar embryological origins. The closer the embryological origins of site of origination of two tumor types, the more similar are the tumor types considered. Two tumors having the same anatomic site of origination are the most similar according to this scale.

Additionally, it is often advantageous to include additional information for possible use in classification, such as clinical stage (based on, for example, tumor, node involvement, presence of metastases, volume of largest tumor, and so forth) appropriate for the particular cancer, history of prior treatment (primary, recurrent), clinically known patterns of sensitivity and resistance, and so forth. Further, this additional information can include clinical experience relating to the responsiveness of the tumor type in general, or to classes of agents, or to particular agents.

In further embodiments, the reference tumor response data (and actual assays of the patient tumor of interest) can include relevant molecular characteristics of the reference tumors and the patients (or groups of patients) tumors. Molecular characteristics can include known genetic characteristics, such as the presence or absence of known genetic abnormalities (oncogenes) associated with the tumor of interest, for example presence or absence of mutations in the BRCAx genes in breast cancer, p32 generally, and so forth. Further, these characteristics can include particular molecular targets, such as products of oncogenes, enzymes generally, cytokines, aptamers, siRNA and other nucleic acids, cellular receptors, and other characteristics known to those of skill in the art as being important in tumor origination and progress. Selecting for specific genetic characteristics has the potential for even more closely modeling biological heterogeneity of a tumor of interest with reference tumor response data.

The particular chemotherapeutic agents for which assay data is important depend on the current use of the invention. For example, when the invention is applied to aid a physician in selecting treatment plans, the preferred assay reference data is for agents likely to be useful to the physician, for example by having regulatory approval along with reasonably well known pharmacokinetics (using dosage parameter and agent combination information), toxicities, interactions, and so forth. In this application, the tumor reference data preferably includes data in those reference patients having the tumor type in the patient of interest. Alternatively, it can be limited to such data.

When the invention is applied to ranking the effectiveness of new agents or new combinations, the preferred assay includes these new agents and components of the new combinations, whether the components are old or new agents. In particular for new agents, the reference data is initially modeled to approximate that which would be obtained for the new agent if it were minimally acceptable after Phase II trials according to Food and Drug Administration (FDA) standards. Here, the new agent is assayed against a broad range of tumor types and only data from the 20% of best sensitive tumor types is used initially for triage recommendations and for setting of TDCs for testing combinations of agents. Subsequently, should the clinical translation (such as observed response rates) prove effective at the 66% or greater level, or lower level depending on the empirical clinical alternatives, the threshold for defining sensitivity can be reset so that a larger fraction of patient's can be offered therapy. Here, the tumor reference data preferably includes data from tumors in reference patients that are likely to be response to the new agents or combinations.

The assays are conducted in the laboratory (considered either in vitro or ex vivo) on samples of tumor tissue of a particular type obtained from a particular patient. In one embodiment, the preferred assay method is the ATP-TCA assay, which is fully described elsewhere in this application. However, the invention can be used with any assay method that preferably demonstrates correlation with clinical experience comparable to the ATP-TCA assay by, for example, by demonstrating directly good correlation with the preferred ATP-TCA assay itself. Assay data principally comprises several observations of the degree of tumor inhibition at several drug concentrations. Drug concentration is preferably recorded as a percent of the test drug concentration (TDC) for the particular drug as conventionally understood and determined by one of skill in the art. Tumor inhibition is preferably expressed as a percent of inhibition. Alternatively, tumor inhibition can be expressed as a cell viability percentage, or in the case of the preferred ATP-TCA assay, percent of ATP concentration with respect to untreated cells. These two manners of expression are completely equivalent since percent tumor inhibition is in fact determined as one minus percent cell viability.

Importantly, this invention seeks agents and combinations of agents which are adequately active at relatively low concentrations, where low concentrations means preferably less than about 100% TDC, and more preferably less than about 50% TDC. Therefore, it is important that tumor response data include sufficient information from concentrations ranges less than 100% TDC, preferably data from at least two well-distributed exposures in this concentration range, and more preferably four or more well distributed exposures. Most preferably, these exposures are at logarithmically-distributed at approximately 5%, 6.25%, 10%, 12.5%,15%, 20%, 25%, 30%, 35%, 40%, 45% and 50% TDC; the invention is not limited to these exposure concentrations and is adaptable to other exposure concentrations, more concentrations generally producing better results.

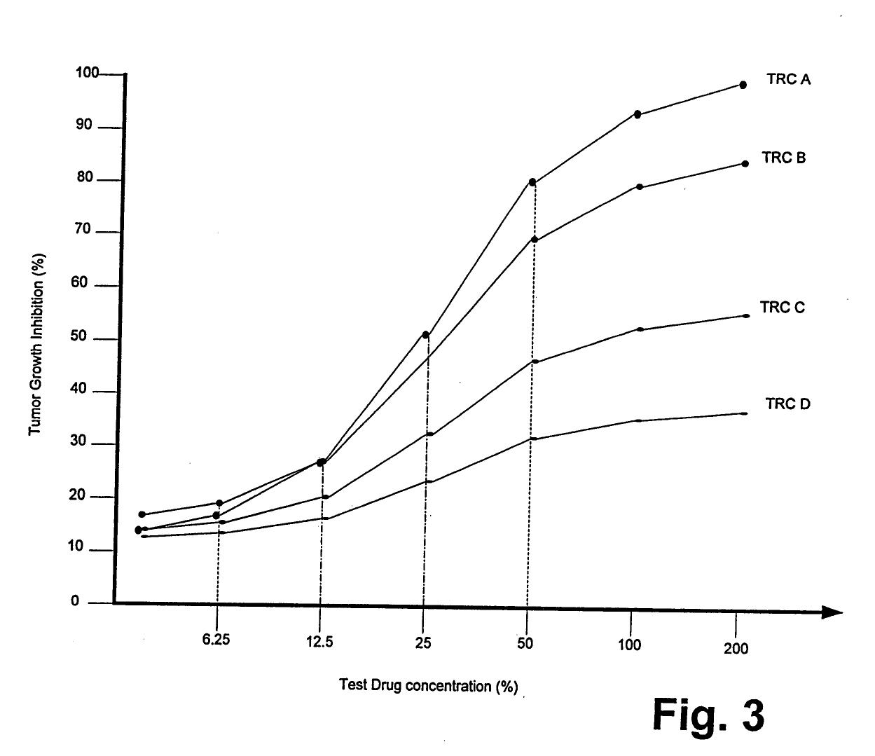

Table 1 and FIG. 3 generally illustrate exemplary tumor response data, which is intended to represent the response of a single type of tumor present in a single patient to four different chemotherapeutic agents, Agent A, Agent B, Agent C and Agent D. Exposure to these agents at the indicated TDC percentages results in the percent tumor growth inhibitions illustrated in Table 1.

TABLE 1
Exemplary Percent Tumor Inhibition

| | Test Drug Concentration (%) | | | | | | |
|---|---|---|---|---|---|---|---|
| Agent | 3.75 | 6.25 | 12.5 | 25 | 50 | 100 | 200 |
| A | 14 | 17 | 27 | 52 | 80 | 93 | 100 |
| B | 17 | 19 | 27 | 48 | 70 | 80 | 85 |
| C | 14 | 15 | 20 | 33 | 47 | 53 | 56 |
| D | 12 | 13 | 17 | 23 | 32 | 35 | 38 |

The data format of Table 1 is generally suitable for storing tumor response date in a computer-implemented database, such as database 11 of FIG. 1. FIG. 3 illustrates a corresponding graphical format of this data, in which, for example, “TRC A” represents the tumor response curve to Agent A. This format of the data is suitable for presentation to a user of the systems of this invention and for certain manipulations, such as finding the area under portions of the curve.

In addition to such tumor (i.e., tumor inhibition) response data, the full practice of the methods of this invention preferably accesses or provides clinical experience data relating to a broad selection of tumor types treated with a broad range of chemotherapeutic agents. Preferably, the tumor types and agents for which experience data can be accessed corresponds to those tumors which are the subject or object of specific applications of the ex vivo assay. At least, the data should include patients with the tumor type of interest and exposed to the agents of interest in the current application of this invention. Where an agent has been used and clinical experience has been accumulated, available data, as is well known, usually is expressed as a “response rate” (herein, in percent) for tumors of particular types and classifications, according to some criterion, such as remission, regression, symptom relief, and so forth. An example of such data is the overall percentage response of primary adenocarcinomas of the colon to 5-fluorouracil. Where an agent has not yet been sufficiently clinically exploited, a response rate can be set to establish a level of efficiency in selection of patient for trial. For example, useful salvage drugs may only produce 10% rate of response in their first trials. Selecting an ex vivo rate of 20% would typically yield a 40-50% clinical rate of response in the initial trials, thereby sparing 80% of patient from an ineffective treatment. Alternatively, a nominal response rate can be assumed, for example 20%, which is one of the threshold criteria used by the FDA for Phase II clinical trials.

Data both of the ex vivo tumor response type and of the clinical experience type are important for the present invention. Heretofore, it has of course been common to express the effectiveness of a particular chemotherapeutic agent simply as a single number that averages the overall response rate observed when this agent is used to treat tumors of a particular (clinical) type in many patients. But as is well known, individual cancers, certainly even cancers having the same overall type or classification, from different patients have considerable biological heterogeneity. This considerable heterogeneity manifests itself in diverse clinical histories or remission, recurrence and progression of the same tumor types upon treatment with particular agents in individual patients. Use of a single response rate largely hides this known biological heterogeneity. In the present invention, this heterogeneity is represented by the in vitro (or ex vivo) response data from selected tumors from multiple patients when exposed to an agent or agents of interest. This response data represents multiple values of tumor inhibitions observed in assays including multiple concentrations of an agent or combination. Therefore, according to the present invention, assessment or ranking of a particular agent or combination for a particular tumor for a particular patient is, preferably, made in view of an overall known clinical response rate, but adjusted for the assay results of the particular patient evaluated against the background or framework of heterogenous assay responses of other patients. In this manner, an individualized estimate of the likely response of the particular patient to an agent or combination can be systematically arrived at.

For example, where prior practices have examined only the “best” anthracycline or alkylating agent of choice (i.e., the “best” agent in each class), in contrast this invention has discovered, and continues to evolves, as test panel of agents and combinations which often includes more than one agent from each class. This flexibility and openness has several advantages from testing for synergism and confirming it to be an agent class phenomenon and not simply a single agent phenomenon, to more reliable methods for effective clinical translations and for the empirical developments that allow the majority of patient to be treated with the least toxic agent of the class, to rescuing agents which are now unsuitable for empirical application because they have produced inferior “overall” response rates used alone, to further advantages that will be apparent.

Accordingly, continuing with the example of Table 1 and FIG. 3, the data accessed or provided in step 21, which can be stored in database or databases 11 of FIG. 1, preferably includes the following data elements illustrated in Tables 2A and 2B.

TABLE 2A
Tumor Response Date From Many Tumor Types in Many Patients

| | | |
|---|---|---|
| Tumor type X in patient Y | Agent A | Tumor response data A |
| Tumor type X in patient Y | Agent B | Tumor response data B |
| Tumor type X in patient Y | Agent C | Tumor response data C |
| Tumor type X in patient Y | Agent D | Tumor response data D |
| . | . | . |
| . | . | . |
| . | . | . |
| Other tumor types in other | Other | Tumor response data for other |
| patients | agents | tumor types from other patients |
| | | exposed to other agents |

Table 2A preferably collects in a common format the chemo-sensitivity/resistance assays of a broad selection of tumor types from a diversity of patients when exposed to a broad range of chemotherapeutic agents. At least Table 2A would have data for the tumor type of interest and for the agents or combinations of interest in a particular patient. Preferably, the database will contain data that in the light of clinical experience is of the most immediate value for the specific tumors and specific histories of prior treatment, content which is unique to the present invention. Examples of such data items include: tumor type, sites of tumor, size of tumors, time of prior treatment, response to prior treatment, un-maintained time of relapse, maintained time of failure, assays of specific molecular targets, ex vivo dose-response curves, clinical outcome translation when known (retrospective versus prospective), other patient medical characteristics, and so forth.

TABLE 2B
Clinical Response Rates of Many Agents in Many Tumor Types

| | | |
|---|---|---|
| Tumor type X | Agent A | Clinical response rate |
| Tumor type X | Agent B | Clinical response rate |
| Tumor type X | Agent C | Clinical response rate |
| Tumor type X | Agent D | Clinical response rate |
| Other tumor types | Other agents | Clinical response rates for other |
| | | tumor types exposed to other |
| | | agents |

Table 2B preferably collects the clinical experience data from a broad selection of tumor types when treated with a broad range of chemotherapeutic agents. Without limitation, these tables are intended as illustrative of the data types and elements accessed or provided and input to the methods of this invention. This invention is immediately adaptable to other detailed presentations and arrangements of this data. Further, in any particular use of this invention, the data accessed can be limited simply to that of immediate relevance, as explained next. Although for maximum flexibility for more general, additional uses, it is advantageous that the systems of the invention have access to database(s) containing the broad range of data.

Alternatively, and less preferred, if tumor response data is not accessible by being already available, for example, stored in computer-implemented databases, the present invention contemplates providing this data by performing the necessary assay measurements as part of step 21. However, any assay data acquired during the methods of this invention, if not already stored in a data base, is advantageously stored therein for later uses of the present invention. Consequently, as the present invention is utilized, a comprehensive progressively more powerful and comprehensive data base in generated.

Turning next to step 22, here the methods of the present invention, generally, select that part, or all, of the accessed tumor response data that is relevant to the current use of this invention. Generally, it is preferable to select that tumor response data which most closely matches all that is known, for example, about the particular tumor of the particular patient. The more closely matching, according to accessible characteristics, is the reference data then the more accurately the reference data models the biological heterogeneity, in particular, the common variations in clinical responses, of the particular tumor or tumor type of interest. For example, if the current use is to assist a physician in selecting agents or combinations for a particular patient, then the response data can be selected as follows. In a preferred alternative, tumor response data is selected for any patient having the same tumor type according to a more fine classification, for example, by being of the same anatomic origin, histological type and clinical stage as that of the particular patient. This can be further refined by knowledge of, for example, past treatments, common patterns of anticipated and demonstrated ex vivo resistance/sensitivity, increase in ATP activity over the test period (control), volume of tumor, source or site of tumor, presence of tumor ascites, and so forth. Further, the response data is selected for the range of possible agents or combinations being contemplated by the physician for treatment and according to whether the tumor tissue is primary or secondary. If sufficient tumor response data (in the sense to be described shortly) results from this selection, then step 22 next ranks the selected data.

If insufficient data results, then the selection criteria are relaxed in order to retrieve sufficient tumor response data. Criteria relaxation, in an exemplary embodiment preferably, proceeds in the following order: first, selecting patients with tumors of the same histological type and similar embryological origins; second, selecting patients with tumors of the same histological type regardless of anatomic or embryological origin; third, selecting patient with tumors treated with or known to be responsive in empirical practice to the contemplated agents or combinations or agents or combinations of agents from similar pharmacological classes (for example, the classes and subclasses of anthracyclines, alkylating agents, anti-metabolites, hormones, and so forth). Further, where molecular characteristics (as defined above) are available for reference tumor response data and/or current patient assay tumor response data, criteria can be selected and relaxed based on such characteristics also. Also, where a new ex vivo test tumor is empirically expected to have certain response rates associated with the use of the certain test agents, a reference panel can consist of tumors which have similar levels of responsiveness to these certain test agents. Generally, one of skill in the art in a particular case will be able to select relevant criteria with which to select more closely, or less if necessary, approximating reference tumor response data.

If the current use of the invention is for evaluating new certain agents or certain new combinations of agents, new or old, then similar data selections can be performed. An initial selection can be of all patients with tumors known to be sensitive to or having been treated with the certain agents or pharmacologically related agents or combinations If a finer evaluation is sought with respect to particular tumor types, then the selection can be further limited to patients with tumors of the particular histological type or anatomic origin, providing sufficient data is available in the more limited selection. An alternative is to create the data base in a fashion similar to that described for identification or selection of a new TDC. Another alternative is to select tumors which as a group are responsive to agents with, preferably, similar mechanisms of action or actual analogues.

In other embodiments, the reference tumor response data (and actual assays of the patient tumor of interest) can include relevant genetic characteristics, such as the presence or absence of known genetic abnormalities associated with the tumor of interest, for example presence or absence of mutations in the BRCAx genes in breast cancer, p32 generally, and so forth. Selecting for specific genetic characteristics has the potential for even more closely modeling biological heterogeneity of a tumor of interest with reference tumor response data.

After having selected sufficient tumor response data, step 22 next ranks the selected reference response data in preparation for comparison with actual tumor response data from a particular patient (in case of such a use of the present invention) with the selected and retrieved reference data. Generally, according to the present invention, the heterogeneity of similarly classified tumors is taken into account by comparing the response of a tumor from a particular patient with the responses of similar tumors in other patients. At the least, the goal is to conclude whether the particular patient's tumor is more responsive ex vivo than most other similar tumors, of average responsiveness, or less responsive than most. In a preferred embodiment, a more finely grained ranking is made using a ranking of approximately 10 levels of responsiveness, preferably from a first, most responsive rank, of 1 to a last, least responsive rank, of 10. The use of 10 levels in the following description is without limitation; a minimum ranking has the above 3 levels, other rankings can have 5, 10, 15, 20, 30 or more levels. In all cases, later, in step 24, measured response data from a patient is assigned the rank into which the most similar retrieved tumor response data has been partitioned.

In more detail and without limitation, the accessed and retrieved tumor response data is, therefore, partitioned into 10 successive levels of responsiveness. In a preferred embodiment, this ranking is according to numerical measures, especially measures depending on the area under the tumor response curves graphically representing the reference response data. Turning again to FIG. 3, preferred measures of a tumor response curve are (i) the area under a tumor response curve from 6.25% TDC to 50% TDC (measure “AUC-1 ”) and (ii) the area from 12.5% to 25% (measure “AUC-2”). These areas can be evaluated by known methods of numerical integration, for example, by the trapezoidal rule. Note that these measures are dimensionless, having units of inhibition percent by concentration percent or simply percent by percent. Typically, either of these measures leads to the same ranking. Tumor response curves where the two measures result in different rankings are individually examined. If their shape is questionable or atypical, they are discarded.

The present invention is adaptable to other numerical measures. For example, a possible measure is simply the value of the tumor inhibition percent at some fixed dose, such as 50% TDC. Another possible measure depends on the sum at two or more fixed doses. Because the invention primarily addresses the low dose behavior of agents and combination, it is preferable in all cases for the measures to depend only on tumor response data from concentrations ranges preferably less than 50% TDC, or less than 75% TDC, or less than 100% TDC. If the invention is applied to high (or extreme) doses, the measures can also depend, possible exclusively, on dose ranges above 100% TDC. Although the emphasis of the present invention is on inhibition at low doses (less than 100% TDC), in appropriate cases data from higher doses can be used. For example, inhibition at higher doses (e.g., at approximately 100% TDC or from 100-150% TDC or greater than 150% TDC) can be used as supplementary information in guiding the choice between agents that are otherwise of equal ranking according to the present invention.

Having determined numerical measures for all the selected and retrieved tumor response data, the data can be ranked by several methods. Preferably, AUC-1, or AUC-2, or a sum of AUC-1 and AUC-2, or so forth, for all the data are placed in order and response data are partitioned into 10 bracketed ranges (also known as “buckets”), each containing an equal number of tumor response curves. Alternatively, the range from the highest to the lowest numerical measures can be divided into 10 equal segments, and each tumor response curve assigned to the segment containing its numerical measure. In a further alternative, partitioning can be done so that bucket occupancy is modeled by a normal curve or other appropriate statistical distribution function. The partitions or buckets are then assigned an integer rank from 1 to 10.

Further, it is preferable that the known statistical errors be included in the ranking process. For example, in one embodiment, the likely error range about the actual assay data is taken into account by finding that range (or partition or bucket) of the reference data that most completely overlaps the entire error range about the actual assay data. In another embodiment, likely errors ranges known with respect to the reference data are taken into account in the partitioning into ranges or buckets. The number of possible ranges cannot be so high that each range has a size which is smaller than the error ranges of its included tumor reference assay data. If the resulting number of ranges is less than the preferred number, the actual ranges taking account of likely errors can be (linearly) scaled to be between the preferred numbers.

Returning to the sufficiency of the tumor response data, it is preferred that for 3, or 5,. or 10, or 15, or more ranks there be at least the same number of selected and retrieved tumor response data or curves, and even more preferably 1.5, or 2, or more times that number. If less than 3 tumor response curves are available, the data is likely to be insufficient. With only 3 or 4 curves, a ranking with 3 or 4 ranks may be used in certain embodiments. For example, if only 5 curves are retrieved, for example, they can be assigned to 5 buckets with the buckets being assigned sequential integer ranks of 1, 3, 5, 7 and 9. Other methods of handling small number of tumor response curves will be apparent to those of skill in the art. For example, the invention supplements the available patient specific family of tumor response curves (or data) with response data of a broader family of biologically (and clinically) related tumors. For a jejunal tumor, related tumors can be all small bowel tumors, or all colon tumors with similar prior treatment (if any). For an ampullary tumor, related tumors may be all small bowel tumors, or all bile duct tumors, or all low-grade pancreatic tumors. Further, in a specific case, analyses can be performed with various classes of similar tumors, and the class with the most consistent outcomes selected for final use.

In sum, at the completion of step 22, the range of responsiveness of reference tumors of types similar to that of the tumor of interest has been divided into, preferably, 10 ranks, each rank being defined by numerical criteria, preferably based on the area under tumor response curves for does ranges preferably between 6.5% and 50% TDC, or other ranges less than 100% TDC.

Next, step 23 simply performs actual chemo-sensitivity/resistance assays appropriate to the current use of the invention. Where the invention is applied to aid a physician in selecting treatment plans, the preferred actual assay data results from exposure of a sample of the particular patient's tumor to agents potentially useful to the physician. Where the invention is applied to ranking the effectiveness of new agents or new combinations, whether the agents combined are old or new agents, the preferred assay includes exposure of, preferably, a broad range of samples of different tumor types to these new agents of the new combinations unless the invention is used to further the development of new combinations directed against a specific tumor type, when it is possible only to assay against samples of that tumor type. Further, it has been discovered that the present invention has broad application beyond particular targeted diseases, especially where agent synergism is discovered which overcomes conventional resistance of a tumor type to one or more agents.

Note that the particular agents or combinations to be assayed have already been selected in connection with the selection of reference tumor sensitivity data in step 21. Step 23, therefore, determines actual tumor response assay that is to be compared to the ranked reference tumor response data.

Next, step 24 determines an initial therapeutic index for the agents or combinations assayed in step 23 by comparing their assay data to the framework of the ranked reference tumor response data obtained in steps 21 and 22. A high initial (and final) therapeutic index represents, according to the present invention, an agent or combination that is likely to be more effective and desirable, whether for treating a particular patient or for determining the outcome of agent screening. Briefly, in step 24, an initial therapeutic index is determined for an agent or combination based solely on the expected responsiveness of a particular tumor or tumor type to the particular agent or combination. Then, in step 25, the initial therapeutic index is corrected according to other important clinical factors, such as cost, toxicity, synergism, low dose activity, analogue support, and so forth, to determine a final therapeutic index.

Important to step 24 is that an agent or combination will have an initial therapeutic index (or probability of success) that is related in an increasing manner (preferably, directly) to the known clinical response rate of the agent or combination and in a decreasing manner (preferably, inversely) related to the rank of the reference data that most closely matches the actual assay of this agent or combination. In other words, the higher known clinical response rate, the higher (or better is) the initial therapeutic index. On the other hand, if the matching reference rank is higher then the actual assay is more similar to less responsive reference data, and the initial therapeutic index is accordingly selected to be lower (which signifies less active). Instead, of selecting treatment for a particular tumor merely on the basis of aggregate clinical response rates, the present invention systematically also relies on an estimate of where the particular tumor lies on the spectrum of observed biological heterogeneity of similar tumors.

A core concept of the invention is to determine the initial therapeutic index so that the initial therapeutic index of a candidate agent or combination depends in an increasing manner as the clinical experiences indicate that the reference tumors are more responsive to the candidate agent or combination, and in an increasing manner as a comparison of the actual assay data for the candidate agent or combination with the reference assay data indicates that the candidate agent or combination is similar to more responsive reference data. Since the more effective the matching reference data the lower is its assigned rank, this core concept can be most simply represented by the following basic relation:

$$\text{Initial Therapeutic Rank} = \text{Factor} * \frac{\text{Clinical Response Rate(\%)}}{\text{Rank Of Most Closely Matching Reference Data(} \text{n} \text{)}}$$

Preferably, the scaling factor is chosen so that the range of initial therapeutic ranks is from approximately 0 to approximately 10. More preferably, the scaling factor is chosen so that the range of initial therapeutic ranks adjusts for errors due to treatment failures unrelated to agent resistance. These factors include performance, protected tumor site, clinical stage, and so forth. This broadens the response to rank additional tumors beyond the strict response rate as candidates. The factor may be adjusted for specific applications as will be understood to one experienced in the art.

$$\text{Factor} = \frac{1}{0.66} = 1.5$$

As will be immediately apparent, this invention is not limited to the above preferable relations. Rather, it is adaptable to any relations, which expresses the above core principle. For example, as more reference data are available and as more confirmations of the results of the present invention are also available, standard curve fitting techniques, for example as known in the statistical arts, can be applied to determine a more accurate basic relation, perhaps depending on further factors also representing biological heterogeneity and expected clinical responses.

The variables input to the basic relations are determined as follows. The clinical response rate is simply the reference response rate for the agent or combination being evaluated. In case no response rate is yet known, a nominal and standard 20% response rate is assumed, as previously described. Further, the response rate is set higher on lower depending on the expense of treatment (lower), availability of subject (higher), anticipated activity (higher), and so forth.

The matching rank is determined by, first, obtaining the same numerical measures for the actual assayed response of the particular tumor (or new agent or new combination). In a preferred embodiment, the numerical measures are the areas under the tumor response curves from 6.25% to 50% TDC (AUC-1) and from 12.5% to 25% TDC (AUC-2). If these two measures give different initial indexes, this agent or combination is examined for an atypical response curve. If found, such an atypical curve is noted for step 25. These measures are then compared with the measures of the reference tumor response curves that are assigned to the various ranks. The assayed patient curve is assigned to the reference rank with the most closely matching numerical measures, in view of including statistical considerations establishing probabilities of error ranges. The most closely matching measures can be determined, for example, by finding the reference rank with reference curves having the smallest square differences from the assayed response curve. Alternatively, statistical clustering techniques can be used to find the most similar reference tumor response data. (These techniques can also be used to arrive at the partition of the reference data and the initial reference data ranking).

Continuing with the example of Table 1 and FIG. 3, Table 3A illustrates a possible determination of initial therapeutic indexes. Single agent tumor response curves are illustrated in FIG. 2; arbitrary combination tumor response curves and clinical response rates have been assumed for illustrative purposes. The columns for Toxicity/Cost and Final Therapeutic Rank pertain to step 25 and are not applicable in Table 3A.

TABLE 3A
Initial Results for Tumor Type X in Patient Y

| | | | |
|---|---|---|---|
| | Initial | | Final |
| Agent or | Therapeutic | Toxicity/ | Therapeutic |
| Combination | Index | Cost | Index |

| | |
|---|---|
| A | 8 |
| B | 6 |
| C | 4 |
| D | 2 |
| A + B | 7 |
| B + C | 8 |
| B + D | 9 |
| C + D | 5 |

Table 3A illustratively presents important aspects of the present invention, namely its ability to precisely characterize the effects of combinations of agents in specific instances in a manner that clearly distinguishes dose related effects from combination effects. For example, the combination A+B has an initial index of 7, which is less than the better agent, A, but better that the worse agent, B. In other words, over corresponding dose ranges from 6.25% or 12.5% to 25% or 50% TDC, B is clearly antagonistic to the action of A. On the other hand, the agents B and C have a merely additive effect in the combination B+C, the increased index of B+C is due to the independent effects of B and C alone. In contrast, over corresponding does ranges, D is clearly synergistic to B in the combination B+D. The index of this combination is far beyond what would be expected from the independent effects of both agents acting independently.

In a more precise embodiment, synergistic effects of a combination can be characterized as effects beyond what would be expected by the agents of the combination acting independently, and antagonistic effects are effects less than independent action. At any given dose, agent A, with a tumor inhibition fraction of R_{A} and agent B, with a tumor inhibition fraction of R_{B}, acting independently would be expected to have a tumor inhibition given by the relation for summing independent probabilities.
Joint Inhibition Fraction=R_{A}+R_{B}−R_{A}*R_{B}

With this relation, the expected tumor response curve for the independently acting combination of A and B, and its initial therapeutic index, can be determined from the curves for A and B alone. In this manner, the presence of synergistic or antagonistic effects at corresponding doses can be precisely determined from the data available in this invention. Thereby, effects due to extreme doses can be separated from true agent synergy. In more detail, assay data regarding synergy can be advantageously further analyzed according to the methods such as described in Chou et al. to determine whether synergism is present at lower concentrations, which is desirable, or conversely, whether antagonism is limited to high doses.

Turning lastly to step 25, according to the methods of the present invention, a final therapeutic rank is determined by adjusting initial therapeutic rank in view of further important characteristics of the assayed agents or combinations. These factors include, but are not limited to, such clinically relevant information concerning an agent or combination as the degree of toxicity, the expected cost, the presence of apparent synergy or antagonism in a combination in a particular tumor, the existence of salvage regimens for an agent or combination, and so forth. In particular, it has been found as part of the present invention, that the presence of synergy in a combination assayed against a particular tumor is a significant extra predictor of clinical success in the patient with this tumor. Conversely, the present of antagonism is a predictor of sub-optimum response and increased toxicity, because the benefit of one the agent is suppressed by another agent. Further, agents or combination indicated by this invention to be particularly effective are also even more likely to be also clinically effective. Therefore, it is important to take these factors into account beyond the initial results from the in vitro assays.

These factors can by systematically taken into account by various methods that will be apparent to one of skill in the art in view of the following description. For concreteness but without limitation, the following description is in terms of “rules” which can be applied to the initial therapeutic indexes and additional input information concerning each agent or combination. As is well known in the art of rule-based and expert systems design, such rules can be learned from specialists in cancer treatment, especially experts in the use of the chemotherapeutic agents or combinations, and then can be applied to adjust the initial therapeutic indexes by execution of a rule-based system. For example, such rules can also be adjusted to reflect the experiences of a particular physician user. Accordingly, since the exact rules used can vary among the various implementations of the current invention, the present invention is intended to include use of rules depending on information about the agents or combinations beyond the previously described assay data in order to adjust initial into final therapeutic indexes. More generally, this invention is also intended to include the use of methods other than rule-based systems capable of carrying out similar adjustments in order to perform this adjustment.

In view of the above, the following are a series of preferred adjustment rules for use in the current invention. It is to be understood that any or all of the specific functions and the actual parameter values used in the following illustrations are refineable and adjustable to meet specific needs of individual users, of institutions, of third parties, of clinical development groups, or so forth, all of who may have differing priorities. Further, in specific application the rules, functions and values can be further refined and adapted so that they are specific for certain tumor types, certain patient types, as welt as for certain users. In the following “ITI” and “FTI” stand for “initial therapeutic index” and “final therapeutic index”, respectively. The factor f in rule 5 is preferably approximately 2.

TABLE 4
Exemplary Rules for Determining Final Therapeutic Index

| NO. | RULE GOAL | RULE EXPRESSION |
|---|---|---|
| 1 | Account for | FTI = MAX( ITI, 8 ) |
| | exceptionally potent | |
| | scores of | |
| | agents/combinations | |
| 2 | Account for toxicities | IF (toxicity moderately above average) |
| | or interactions of | THEN (FTI=ITI−1.5); |
| | agents/combinations | IF (toxicity is much above average) |
| | | THEN (FTI=ITI−2.5) |
| 3 | Account for costs of | IF (costs moderately above average) |
| | agents/combinations | THEN (FTI=ITI−1); |
| | (in view of patient | IF (costs much above average) |
| | resources) | THEN (FTI=ITI−2) |
| 4 | Account for synergies | IF (synergy present) |
| | or antagonisms of | THEN (FTI=ITI+3) |
| | combinations | IF (antagonism present) |
| | | THEN (FTI=ITI−3) |
| 5 | Account for a | IF (N further useful salvage combinations |
| | selection that creates | found) |
| | useful salvage | THEN (FTI=ITI+f*N), |
| | regimens | where f is from 0.5 to 2 |
| 6 | Account for potential | IF (potential reuse found) |
| | use of an agent in | THEN (for combinations) (FTI=ITI+3) |
| | effective combination | |
| | with less effective | |
| | agents otherwise | |
| | useless | |
| 7 | Account for atypical | IF (shape of tumor response curve is |
| | responses of | atypical) |
| | particular tumor | THEN (FTI=ITI−1) |

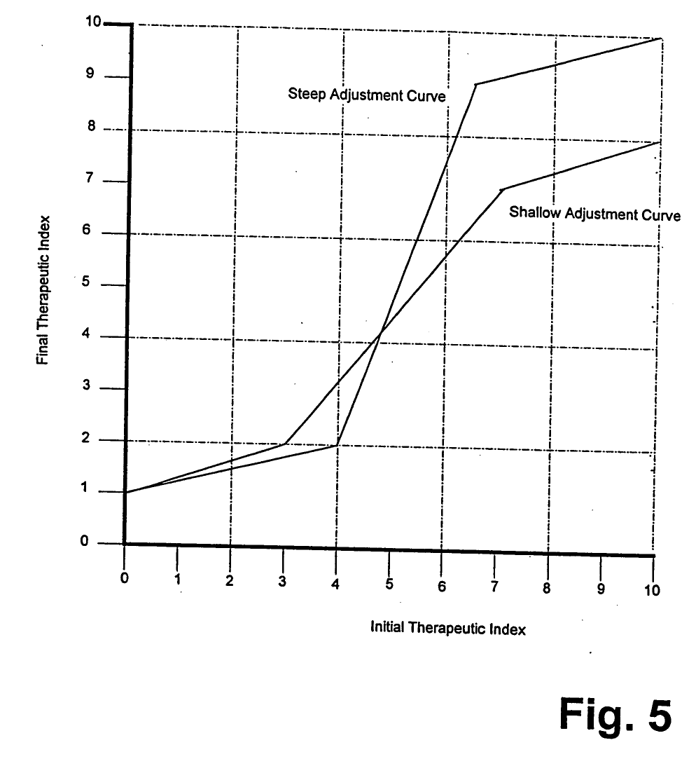

In more detail, the first rule limits the FTI for agents or combinations whose assay indicates exceptional potency, for example by having their ITI among the best 25%, in order that such potency does not swamp the importance of other critical factors that importantly influence the FTI. Alternatively, for certain users of patients, the first rule can represent that exceptionally potent should have high FTIs whether or not their toxicity, costs, or other factors weighs against their use (e.g. such a rule is IF (ITI>7) THEN (FTI=ITI+3)), because exceptional potency indicated by assay data can be an independent predictor of clinical effectiveness. A more general form of rule useful here in accounting for exceptional potencies is illustrated in FIG. 5. The two exemplary curves in FIG. 5 provide general relations between the ITI and the FTI that also reflect, but more generally, the prior two alternatives. The “Shallow Adjustment Curve” reflects that agents or combinations with exceptional potency have their FTIs continuously capped to not exceed an index of 8. Here, the influence of factors other than potency is permitted to have relatively greater effect on the final ranking The “Steep Adjustment Curve”, on the other hand, increases the FTIs of agents with better than average ITIs. In this case, potency is the factor of importance, and the influence of other factors has relatively less effect on the final outcome. It will be clear that other priorities can be reflected in other forms of adjustment curves, even in smoothly varying curves. In general, the best 10% of curves have similar chances of response and the preferred embodiment is to apply a cap so the best of curves for a 65% response rate agent are in practice similar to the best 57% of curves for a 30% response rate. Therefore, a cap is preferable to allow application of secondary FTI rules. Further, although not specifically discussed in the following, such more generally varying adjustments can be readily applied, if necessary, to the other factors, such as the presence of synergy, the degree of toxicity, and the like.

Next, the second rule considers the total toxicity of an agent or combination, both its tangible economic costs to a patient and its intangible degradation of a patient's quality of life, and decreases the FTI in proportion to these toxicities. The third rule similarly decreases the FTI in proportion to the cost of an agent or combination (in view of the patient's resources). The fourth rule represents the clinically predictive effect of synergies or antagonisms observed in the in vitro or ex vivo assays, an effect which has been discovered as part of this invention. In detail, this invention has discovered that agent synergy, which was formerly considered a laboratory oddity, has clinically important frequency and breadth of occurrence. In has further been discovers, that combinations known to be synergistic on average can actually be antagonistic in individual patients and for individual tumors.

The fifth and sixth rules represent different aspects of finding strategic uses of agents or combinations that are important because they provide, possibly multiple, future effective therapy options even after relapse from a primary therapy (in some cases even providing for reuse of agents which have previously failed). Generally, the concept of strategic use of agents, such as creating salvage opportunities, involves determining a sequence of regimens using and (when possible) reusing effective and ineffective agents, alone or in combinations, that provide at least one, and preferably multiple, useful treatment opportunities (beyond primary therapy). Strategic use often involves redistributing standard empirically known agents or combinations for use at different times and in new combinations effective in a particular patient or particular group of patients. Rather than merely using a standard or best empirical combination in all similarly classified patients, informed by the results of the methods of the present invention, agents previously used in primary standard therapy are now used to form additional regimens by delaying, reserving or revising their use for a second regimen (or combination). Other agents in the second or further regimens may be individually active or inactive. If individually inactive, strategic use employs the agent in effective combinations with other agents. Thus, according to the fifth and sixth rules, the FTI is higher if an inactive drug is made useful, especially a drug which would be used empirically. The FTI score is further increased if empirically important drugs are salvaged or diverted from otherwise antagonistic or ineffective uses or combinations to create additional useful regimens non-cross-resistant with other active agents. For example, the FTI score is further increased if a useful pair of additive or synergistic drugs can be divided to create two new useful, preferably additive or synergistic, combinations with agents that would be otherwise ineffective (or are newly discovered).

In general, such strategic use is determined by assaying multiple agents and their binary (and higher order) combinations according to the present invention for effectiveness against a particular tumor, or particular type or group of tumors. The systematic and reproducible methods of the present invention permit determining ITIs and FTIs in a particular clinical situation which are broadly comparable. Therefore, the present methods make possible the combination of agents not previously believed to be active but are now found to be active in new combinations. For example, these include agents previously the first-choices but now found to be more useful in new combinations, agents displaying ex vivo antagonistic or synergistic interactions but now found to be usable in more potent, additive or safe combinations, single agents alone, whether previously effective or ineffective or whether previously commonly used or not, but now effectively used as sequential combinations. Further examples are described elsewhere herein.

Thereby, in favorable situations, upon systematically comparing agents and combinations according to the disclosed methods, more multiple effective treatments regimens (according to their FTIs) can be identified, and their sequential use planned. These methods bring a larger number of treatment regimens and agents into active use by emphasizing a total sequence of treatment, instead of being limited to the prior emphasis on only a single best regimen. Preferably, as described, the FTIs of agents are increased if they are part of identified regimens involving strategic use, either by salvage, or by new use in new combinations with agents previously thought to be ineffective, or by other identified commonality among the effective regimens.

In detail, the fifth rule represents the importance of strategic use in primary or salvage regimens, in which an important, but now inactive or antagonistic, agent, or agents from an important class of agents, can be reserved primarily for later use, or used again, or “salvaged”, in a particular clinical situation, optionally in combination with another active or otherwise inactive agent or agents or an active or an otherwise inactive concentration of an agent or agents. Alternatively, salvage can occur if the additional agent or agents results in activity for an otherwise inactive concentration of the important agent to be used or reused. The exemplary rule illustrated here increases the FTI in proportion to the number of newly active combinations found, and in order to reflect the clinical significance of “salvaging” (or avoiding antagonistic use of) an empirically useful drug for a series of future treatments in a particular situation. Alternative rules, can, for example, cap the increase in the FTI by some fixed cap, e.g., to an increase of +3 or less. In another aspect, salvage regimens can make second or third treatment use of an agent which is normally used for primary treatment because other effective agents or novel combinations have been identified for primary treatment.

Alternatively, it can be found that currently active agents or combinations have additional activities as parts of additional combinations. For example, it can occur that, where the combination AB (of agents A and B) is active while the agents C and D and the combination CD are not, the further combinations AC and AD are indeed also active. The sixth rule reflects that an active agent or combination is strategically even more useful when it can be effectively reused. Alternatively, this rule can not only increase the FTI of agents having effective reuse in other combinations, but can also reduce (by, for example, −2) the FTI of a combination of active agents that have active reuse combinations. In the above example, the rank of combination AB is reduced while the ranks of agents A and B are increased. This reflects the clinical goal of not squandering two effective agents by administering them in combination where effective alternatives exist separately involving both agents alone or in other combinations.

Preferably, the identified salvage and reuse regimens are effective and do not demonstrate antagonistic effects predictive of a lack of clinical success. More preferably, combinations for salvage and reuse regimens will be at least additive, and most preferably synergistic.

Finally, the seventh rule takes into account any unusual or atypical aspect of the tumor response curve for a particular agent or combination, for example its having significantly different AUC-I and AUC-2. measures, or its revealing a response curve “too good (or bad) to be true”, e.g., an alkylating agent having a too flat a response curve or an anti-metabolite having a too steep a response curve (neither behavior is expected for these classes of agents).

It is not intended that this invention is limited to the rules described above. Any clinically relevant rules can be included to determine the final FTI from the initial ITI. The following lists briefly certain additional possible rules. In this list, typical index adjustments are represented within parenthesis.
The agent or combination that is the best empirical choice also has the best response rate (+1-2, depending on size of advantage).
There is a lack of clinical translational (i.e., response rate) experience with an agent (−2) or a combination (−3).
There is a lack of empirical experience with an agent (−2) or a combination (−3).
There is a lack of preclinical literature or experience concerning possible agent interactions in a combination (−2).
Antagonism (or synergy) is not in the reference agents or combinations assayed (+1, −1.5, respectively).
Absence of dose responsiveness, such as an early plateau in the response curve (−2).
Sufficient strength is already present at lower concentrations of the more empirically important or the most toxic agent, meaning it is possible to give agent with greater frequencies at lower doses but still achieving better cumulative cellular responses (+3, +2.5, respectively).
There exists a sufficiently active two-agent combination of two individually clinically-preferred (or clinically unpopular, or clinically difficult such as by being toxic) but less active agents (+2, −1, −1, respectively for one agent, and +4, −2, −2, respectively for two agents).
The evaluation of a particular patient's case indicates a greater or lesser tolerance to particular agents, toxicities, and so forth.
(and similar rules).

In all rules used in the present invention, exact boundaries for applying the rule and the change in index due to the rule are selected according to clinical need. This selection is within the understanding of a clinician of skill in the art. For example, average, above average and below average toxicity can be selected based on the condition and tolerance of the patient as evaluated by a clinician according to any convenient scale. Finally, as understood by one of skill and experience, it can be useful in certain embodiments to limit adjustments to the ITI in order to determine an FTI to agents with similar statistical and probability ranges of achieving responses. Statistical factors (applicable to both ITI and FTI) includes standard errors estimated a priori as well as from replicated assays, the false positive rates of specific assay methods, recognized variances due to massive tumors, resistant sites of metastases and so forth, and other clinical factors indicative of poor performance or less predictable clinical translation of laboratory results. These factors can be incorporated in ranking the actual assay data to determine the ITI or as rules and other adjustments used to determine the FTI.

It will be apparent to those of skill in the art that by tailoring the rules used, in particular their forms and parameters and the specificity of their input data, the present invention can be adapted to different goals. For example, particular type of agent toxicities, e.g., neuropathies, granulocytopenias, or so forth, can be recognized and further agents that potentiate such toxicities can be avoided in a particular patient by decreasing the FTI of such combinations. Further, the emphasis of the final therapeutic index on agents that are particularly safe, cost effective, particularly effective, and so forth, can be increased. Thereby the invention can be of various uses to third party payers, the medical research community, and other medical constituencies.

Table 3B illustrates a final elaboration of prior examples previously illustrated in of Table 1, FIG. 3 and Table 3A. Table 3B uses the index adjustment rules of Table 4 to illustrate a possible determination of final therapeutic indexes. Arbitrary value for the Toxicity and Cost have been assumed for illustrative purposes; further for illustrative purposes only, the factor “f” in rule 5 has been assumed to be 0.5.

TABLE 3B
Final Results for Tumor Type X in Patient Y

| | Initial | | Final |
|---|---|---|---|
| Agent or | Therapeutic | Toxicity/ | Therapeutic |
| Combination | Rank | Cost | Rank |
| A | 8 | high/high | 3.5 |
| B | 6 | low/low | 7 |
| C | 4 | low/low | 4 |
| D | 2 | low/high | 0 |
| A + B | 7 | high/high | 1.5 |
| B + C | 7 | low/low | 10 |
| B + D | 8 | low/high | 10 |
| C + D | 5 | low/high | 3 |

In detail, for agent A, rule 1 has not effect, while the cost and toxicity rules result in a correction of −4.5. Thus the FTI of A is 3.5. Agent B participates in an additive salvage regimen B+C and in a synergistic regimen B+D, thus rule 5 adds 0.5*2 for each of these possibilities. For agent B there is no other applicable correction, which results in an FTI of 7. For agent C there is no correction, while for agent D there is cost correction of −2. Next, since agent B is involved in three effective combinations, one with the independent effective agent A and two with the ineffective agents C and D, rule 6 increases the ITI of B+C and B+D by +3 and reduces the ITI of A+B by −2. Also, assuming C and D are actually empirically effective agents, since combinations B+C and B+D represent salvage regimens for C and D, rule 5 adds 1 to the ITI of each of these combinations. Therefore, in net, for combination A+B, there is a cost/toxicity correction of −4.5 an antagonism correction of −1, and a correction of −2 due to rule 6. The net is an FTI of effectively 0. For combinations B+C and B+D, rule 5 and rule 6 result in a net correction by +4. For combination B+D, there is an additional −2 cost correction. Finally combination C+D has a −2 cost correction. In determining Table 3B, the overall rule that the ITI must be between 0 and 10 has been assumed.

The large changes in the final therapeutic indexes with respect to the initial therapeutic indexes illustrate the potential importance of step 25 in making clinically significant corrections.

Finally, at step 26 the final therapeutic indexes are output to a physician or other user for, inter alia, devising patient treatment plans. Each regimen, that is each agent and each combination of agents, is output at least in summary form giving the therapeutic ranks determined. Preferably, also the reasons for the regimen ranking, both the initial therapeutic index and also the final therapeutic index, are output advantageously in an easy to understand explanatory form, for example in (perhaps formalized) English. This includes how each additional relevant factor resulted in the adjustments leading to the [mal therapeutic index. Thereby, physicians and other medical personal can readily understand the rankings, and determine whether they are sufficiently credible so that treatment decisions can be based on them. Further, the output can be used to explain treatments to the patient to obtain properly informed consent.

For example, the final therapeutic indexes illustrated in Table 3B clarify how the results of the present invention can be used to devise long term treatment strategies. For example, in view of the final therapeutic indexes for the assayed agents and combinations, a reasonable clinical strategy consists of: (i) use highly effective combination B+D alone first; (ii) use B, or B+D, or both as sequential salvage treatments; and (iii) save more toxic agent A for use last if necessary. For another example, although not represented in Table 3B, it could be possible to get added advantage from the two weaker agents, C and 0, by combining them with the stronger agents, A and Bas AC and BD, respectively.

In view of the above description and accompanying figures, it will be immediately apparent to one of average skill in the art how to implement the methods of this invention for controlling a computer system, for example system 1 of FIG. 1, to practice the present invention. For example, these methods can be implemented in such computer languages as Visual Basic, C or C++. Necessary data bases, either centralized or distributed, can be stored in a relational format and accessed through, for example, embedded SQL statements. If a rule-based programming paradigm is used, this can be implemented by any of the suitably general rule-based and expert system packages that are commercially available. For example, such a package is CLIPS available at www.ghg.net/clips.

Another, less preferred, embodiment of the present invention addresses the case where reference tumor response data relevant to the agents or combinations to be assayed in the particular tumor in the particular patient is substantially entirely absent. In this embodiment, the plurality of agents or combinations assayed in the particular patient are themselves used as one or more of the references against which to rank themselves. Further, if no clinical response data is available, then a nominal 20% (or other expected rate) response rate is used. The actual patient assay data can they be evaluated by, for example, dividing the range between the most and least responsive agent or combination into, e.g., 10, equal index ranks, or, alternatively, by simply indexing the response data, beginning with the best and ending at the least responsive agent or combination, or by the other previously described methods. Then, using this ranking or indexing and the clinical response rate, whether known or assumed, the prior methods can be used to select agent or combinations. The ex vivo response data is evaluated with the prior numerical measures, such as the area under the curve in a concentration range entirely less that 100% TDC.

Further, by using statistical or other known methods, relationships can be derived to compare each regimen's chance of producing a clinical response, relationships which can be improved automatically as more response data and clinical experience is acquired. Since it is likely that several comparably effective regimens will be found for each clinical situation, certainly within the error ranges of the data input, further clinical goals, such as those described above, can be incorporated into the analysis. As above, a rule-based system using rules derived from clinical experts can be used, or alternatively, a neural network, or other leaning method, can be employed.

In an even simpler embodiment, the agents with the more responsive assay data can simply be selected for use. It is more preferred to consider the direct influence of clinical response rates and the inverse influence of a comparison with previous patients having similar tumors.

In another embodiment, when used to assess effectiveness of drugs for clinical therapy, e.g. as an adjuvant for clinical trials, the data processing system and method uses data obtained in in vitro or ex vivo tumor chemo-sensitivity/resistance assays conducted using a variety of samples of types of cancer, cancer cell lines, or a combination of any of the above. In particular, the present invention can be used to predict the outcome of proposed clinical trials, Phase II trials but especially Phase III trials. Accordingly, the effects of schedule. and dose intensity strategy, or the effect of drug substitution or addition strategies, or so forth can be predicted. This has been successfully accomplished for ovarian and pancreatic cancers.

For agent screening, in addition to only cytotoxic agents, further agents not known to be particularly cytotoxic can be screened in combinations for adjuvant or synergistic effects with cytotoxic agents.

The present invention also provides, in an alternative embodiment, for refinement of the ranking methods and adjustment rules under the guidance of an expert in oncology and in particular tumor types of interest. Further, the system of this invention can incorporate access to such experts who can provide further consultation to users as the selection of databases, methods and rules for particular applications.

The methods of the present invention are further applicable to cell lines, or to xenograft tumors, or to other sources of tumors. All forms and classes of agents can be used in the methods of the present invention, including, but not limited to, known cytotoxic, novel or non-classical cytotoxic agents, hormones, antibodies and agents conjugated to antibodies, antisense agents, gene therapy agents, vitamins and vitamin analogues, radiation therapy, electromagnetic fields, and other classes.

Chemo-Sensitivity/Resistance Assays

According to a preferred embodiment, the chemo-sensitivity/resistance assay employed to provide tumor response data for the systems and methods of the invention is the ATP-TCA assay described previously in detail (e.g., Andreotti et al., 1995, Cancer Res., 55:5276-82; Hunter et al., 1993, Eur. J. Surg. Oncol, 12:242-49; Kurbacher et al., 1996, Breast Cancer Res. Treat., 41:161-70). This invention is not limited to this preferred assay. Preferably, any in vitro or ex vivo assay that provides correlation with clinical results of individual patient can be used. More generally, any assay can be used that provides some quantitative measure of cell death of a surrogate measure of cell death or growth capacity. For example, an assay with a growth static endpoint would provide useable analytic opportunities.

Briefly, the ATP-TCA assay is conducted as follows. First, aseptically obtained solid tumor specimens are dispersed using, e.g. surgical scissors and scalpels. Subsequently, tissue fragments of 0.5 to 2 mm in diameter are enzymatically dissociated into a cell suspension of single cells and small aggregates by incubation for 4-18 h in 5-10 ml sterile collagenase-containing enzyme preparation such as tumor dissociation enzyme preparation, TDE. Commercially available from Atlantic Scientific, Fort Lauderdale, Fla., or from DCS Innovative Diagnostic Systeme GmbH, Hamburg, Germany. Alternatively, tissue fragments are dissociated using 1.5 mg/ml collagenase H (Sigma Chemical, St. Lewis, Mo.) or by mechanical desegregation. (see, e.g., Myatt et al., 1997, Anticancer Drugs, 8:756-762) After filtration and ficoll-hypaque density centrifugation, e.g. (Lymphoprep®, ICN Flow, Meckenheim, Germany; Histopaque, Sigma Chemical, St. Louis, Mo.), the quality and viability of resultant single cell suspensions are determined e.g., by trypan blue dye exclusion (0.2% Merck, Darmstadt, Germany) and by subsequent cytological examination. A serum-free Complete Assay medium (CAM) available from DCS Innovative Diagnostik Systeme GmbH, Hamburg, Germany is added and cell suspensions then are adjusted to a final concentration of 1-2×10⁵ viable cells per ml.

Bone marrow, peripheral blood, and pleural and ascitic fluid specimens are prepared by Ficoll-Hypaque density gradient centrifugation (Histopaque; Sigma). Ficoll Hypaque is also used to reduce erythrocyte contamination and increase cell viability for some solid tumor specimens. Cells are washed twice and resuspended for assay in a cell culture medium such as Complete Cell Culture Assay Medium (CAM). DSC Innovative Diagnostik Systeme GmbH, Hamburg, Germany, at 1.0-2.0×10⁵ cells/ml. CAM containing 10% serum can alternatively be used.

Drug assays can be performed in 96-well polypropylene microtiter plates (round-bottom). Test drug concentrations (TDC) are prepared directly on the plates by serial 1:2-dilutions of the individual stock solutions. Each drug is tested by continuous exposure in triplicate at a number, e.g., six different concentrations ranging from 6.25% to 200% of test drug concentration. Appropriate controls, e.g., one with CAM, i.e., no inhibition control, (MO) and the other with Maximum ATP Inhibitor (MI) instead of the cytostatics, can be used in six wells of every culture plate.

Test drug concentrations (TDC) can be defined in several fashions known to those of skill in the art. In one fashion, TDCs are defined on an absolute scale based on observations of concentrations actually achieved in patients. For example, referential concentrations (i.e., peak clinical concentrations PPC) are used to define 100% test drug concentration, or TDCs can be derived from pharmokinetic data. Further, TDCs can be defined on a response-relative scale. For example, a TDC for an agent can be set so that 10% of tumors are 75% inhibited at 12.5% TDC, or 25% of tumors are 50% inhibited at 50% TDC. The method and choice of a TDC can be responsive to the goals for which it is used including, for example, for drug development, clinical trial design, scheduling sequence strategies, simple selection of treatments for standard drugs in standard patients.

According to other embodiments, other appropriate controls novel to the present method include: analogs of drugs or drugs with same mechanism of action in order to confirm the interaction is reproducible for a class of drug and tumor; simultaneous testing of a known cell line when using new reagents, simultaneous testing of new and old reagent before switching to new reagent, also (extreme values off the scale top 5% bottom 5% are suspect) shape of curve must conform to historical curve forms. Other quality control tests include pathology reviews, pH media quality analysis, incubator related evaluation, plate geographic inhibition, and other controls known to those of skill in the art.

Subsequently, a sample, e.g. 100 μl of single cell suspension (i.e., 10,000- 20,000 cells) is added to each well. Cultures are incubated at 37° C. and 95% humidity in a 95% air, 5% CO₂ atmosphere.

After 5-7 days of incubation, another cytological analysis is performed in untreated MO controls. Subsequently, intracellular ATP is extracted and stabilized. Then 50 μl aliquots of each lysate is then transferred to a liminometer, e.g. a LB-953 liminometer (Berthold, Wildbad, Germany). ATP is measured, e.g. by the “firefly” light reaction after automatically pipetting 55 μl of Luciferin-Luciferase-Reagent (Lu-Lu) to each cell extract. Luminescence response expressed as Relative Light Units (RLU=photons/10) is counted for 10 seconds with a 4 second delay. An ATP standard curve is performed for all assays. MO should be greater than 100 pg/ml ATP. Assays showing mean RLU values of less than 20,000 (MO), a MI/MO-ratio>0.01, or evidence of microbiological contamination are regarded as non-evaluable. End assays are also sampled for pathology, proof that the final wells after treatment contain tumor not benign cells.

According to the present invention, depending upon the application for which the assays are to be used, either a variety of drugs and/or drug/combinations can be assessed against a specific tumor (type) or a single drug or one or more drug combinations can be assessed against a variety of tumor types. Drug combinations can be assessed with both agents tested separately, tested together at the same time on the same tumor sample or tested serially, i.e., one after the other on the same tumor sample.

Further, according to the present invention, assays can be conducted using primary tumor samples obtained before any treatment of the patient as well as at any time during the course of treatment, e.g. during relapse or recurrent or metastatic tumor development.

According to another embodiment, tumors can also be stored for further study by implantation into nude mice. Tumors taken from nude mice after several passages, usually reproduce the original assay. This allows enough tissue to follow up or confirm surprising findings and if helpful to confirm a new interaction in vivo. It also allows enough tissue for additional assays. Tumor taken from the patient and nude mice can be frozen slowly retaining viability and provide additional opportunity for further investigation.

In certain embodiments of the present invention, the results of the ATP-TCA assays are assessed using methods I or II as set forth below and previously described in the literature. (See, respectively, Kurbacher et al., 1996, Breast Cancer Res. and Treat., 41:161-170 especially at 163-164 and Andreotti et al., 1995, Cancer Res., 55:5276 especially at 5277; incorporated herein by reference).

For method I, for each evaluable assay, the survival fraction (SF) for an individual drug concentration (SFₙ) can be calculated as:
SFₙ=(RLUₙ−RLU_{MI})/(RLU_{MO}−RLU_{MI})×100

Data then are graphed as inhibition curves for each tumor and drug by calculating percent tumor growth inhibition (TGI) as 100%-SF. Individual values for IC_{12.5} (drug concentration effecting an approximately 12.5% reduction of SF), IC₂₅ (drug concentration effecting an approximately 25% reduction of SF), IC₅₀ (drug concentration effecting an approximately 50% reduction of SF) and IC₉₀ (drug concentration effecting an approximately 90% reduction of SF) are determined by linear interpolation.

Alternatively, or in addition, a dimension-free sensitivity index (SI) represented by the area under inhibition curve (AUC) can be calculated for each tumor and drug as described in previous publications (Andreotti, et al., Szalay A. Kricka et al. (Eds), Chemiluminescence and Bioluminescence, Status Report, John Wiley & Sons: Chichester, 1993, pp. 271-75; Andreotti et al., Campbell et al., (Eds) Bioluminescence and Chemiluminescence. Fundamentals and Applied Aspects, John Wiley & sons, Chichester, 1994, pp. 403-406; Kurbacher et al., 1994, Anticancer Res., 1994, 14:1961-66; Andreotti et al., 1995, Cancer Res., 55:5276-82) using a trapezoidal rule (Silverman, 1985, Calculus with Analytical Geometry, Prentice Hall Inc., New Jersey, pp. 416-18):

$$SI = 100 \times ( {TGI}_{200 \% PPC} + {TGI}_{100 \% PPC} ) \text{/} 2 + 50 x \\ ( {TGI}_{100 \% PPC} + {TGI}_{50 \% PPC} ) \text{/} 2 + 25 \times ( {TGI}_{50 \% PPC} = {TGI}_{25 \% PPC} ) \text{/} 2 + 12.5 \times ( {TGI}_{25 \% PPC} + ( {TGI}_{12.5 \% PPC} ) \text{/} 2 + 6.26 \times ( {TGI}_{12.5 \% PPC} + {TGI}_{6.25 \% PPC} ) \text{/} 2 \\$$

According to the present invention, it is preferred that this sum only include the terms relating to 50% TDC and less.

The SI level is regarded as a measure for the degree of in vitro chemo sensitivity with increasing values indicating increasing sensitivity and decreasing values indicating increasing resistance, respectively (Andreotti, et al., Szalay A. Kricka et al. (Eds), Chemiluminescence and Bioluminescence, Status Report, John Wiley & Sons; Andreotti et al., 1995, Cancer Res., 55:5276-82).

For method II, the percentage of tumor growth inhibition (TGI) for each test drug concentration is calculated as follows.

$$1.0 - \frac{TDC - MI}{MO - MI} \times 100 = \% TGI$$

where MO=mean counts for no inhibition control cultures, MI=mean counts for maximum inhibition control cultures, and TDC=mean counts for replicate test drug concentration cultures.

AUC values are calculated using the trapezoidal rule. IC₅₀ values are calculated by interpolation. Percentage of coefficient of variation is calculated by SD/mean. The Wilcoxon rank sum non-parametric statistics are used to determine the significance of differences in AUC values with different cell concentrations. Student's t test is used to compare AUC and IC₅₀ values for DEP refractory and untreated patients.

According to a preferred embodiment of the present invention, either method I or II described above is modified to give priority of rank to an agent or combination of agents which show inhibitory activity at 12.5-50% TDC rather than to those agent(s) or combination(s) of agents which show inhibitory activity at >50% TDC.

According to a less preferred embodiment, the ATP-TCA assay is conducted using a known tumor cell line of a cancer type similar to that of the patient tumor. This embodiment may be used when assessing new and untested potential therapeutic agents and may be useful to provide additional information regarding the action of the new agent.

According to another preferred embodiment, the chemo-sensitivity/resistance assay employed to provide raw data for the system and method of the invention is the MTT assay which detects cell viability by visualization of conversion of MTT (3-[4,5 dimethylthiazol-2-yl]-2,5-diphenyl-tetrazolium bromide) by mitochondrial succinate dehydrogenase to a colored or fluorescent product. The MTT is a non-clonogenic assay described previously (e.g., Bellamy, 1992, Drugs, 44:690-708; Klumper et al., 1995, Leukemia, 2:1864-69; Petty et al., 1995, J. Bio/um. Chemilum, 10:29-34; the entire disclosure of each of which is incorporated herein by reference in its entirety). The MTT assay is conducted as described in the literature, e.g., see, Bellamy, supra; Petty, supra).

Generally, whether using the ATP-TCA assay or another laboratory methodology, it is important to assay many combinations of agents at several low concentrations, preferably less than 100% TDC.

It will be immediately recognized by one of skill in the art that the present invention is not limited to the exact methods and reagents described herein, but the above methods and reagents can be suitably modified from the above description and the cited references while still achieving equivalent results. For example, they may be modified for particular tumor types. However, it is preferable for consistency that databases of results be built from assays run by the same methods and the same materials, and even more preferably by the same laboratory and same personnel.

Applications

The present systems and methods can be used in a number of applications, including but not limited to methods for devising treatment protocols for cancer patients, methods for devising protocols for clinical trials for drug discovery and/or development, and the like. The treatment protocols can advantageously take into consideration factors including improved quality of life, cost containment, pre-clinical drug discovery by mass screening of off-the-shelf or novel compounds, etc. according to the novel criteria of the present invention.

Treatment Protocols

In one application, the systems or methods of the invention are used to devise a treatment protocol for an individual cancer patient. In this application, after an initial diagnosis of cancer or any decision point in the disease, a sample of the patients' tumor is obtained and a chemo-sensitivity/resistance assays are conducted as described herein. The data obtained are analyzed using the methods described herein, and the results are used by a physician-user to devise an optimum treatment protocol for the individual patients' treatment. As would be understood by those skilled in the art, should the patient relapse after initial or even follow-up treatment, the assay and data analysis can be repeated as necessary. Alternatively, the information can be used to devise a salvage or multi-step strategy from the beginning.

In particular, it is preferable to select candidate agents and their combinations from clinically known and already approved agents. Where new agents or old agents that did not receive approval for chemotherapeutic use are to be considered as candidates, these agents can also be included. These selected agents are then ranked with final therapeutic indexes as described above. Finally, those agents with the “best” indexes are selected for possible treatment protocols. “Best” agents, for example, include preferably those agent with final indexes ranked in the top 10% of the agents, or in the top 20%, or in the top 30%, or in the top 40%, or in the top 50% (depending in certain part on the number of candidate agents and combinations).

In another application, the systems or methods of the invention are used to devise optimum treatment for a class-or group of patients diagnosed with a particular type of cancer. Illustrative examples of useful “types” of “classes” of cancers include but are not limited to: primary or secondary breast, pancreatic, ovarian, liver, lung, stomach, brain, prostate, colon, uterine, melanoma, etc. In this application, historical data collected from a number of chemo-sensitivity resistance assays (described herein) conducted on tumors of patients with the same type of cancer and analyzed using the methods described herein, are used to devise optimum treatment protocols for patients diagnosed with the particular type of cancer. In an embodiment of this application, the data is collected from assays conducted using tumors from patients without prior treatment, tumors from patients with prior treatment, i.e., tumors known to be resistant to one or more drug(s) or both types of drug(s). This application is advantageously used, for example, in cases where the primary care givers do not have access to facilities to conduct individual assays for individual patients. This application can also be used for health care managers or providers of health care insurance to determine optimal treatment protocols or to determine treatments for which reimbursements should be made.

Agent Screening

In further embodiments, the methods and systems of the present invention can be used as a laboratory aid to improve the effectiveness and focus of the pilot studies, phase I, or phase II needed to screen agents or combinations for new uses including, for example, agents that previously failed or not successfully been tested in one or more clinical trials for the same or a different disorder, against the same or different types of tumors. According to such an embodiment, data obtained from in vitro or ex vitro chemo-sensitivity/resistance assays of a variety of new agents and/or combinations of agents or a variety of agents and/or combinations of agents not yet approved for clinical use against a relevant cancer type are assessed against a panel of tumor samples of a given type, such as primary breast, uterine, ovarian, lung, colon, brain, prostate, pancreatic, etc., secondary breast, ovary, uterine, ovarian, lung, colon, brain, prostate, pancreatic cancer, etc., and/or against a variety of relevant cancer cell lines known to those skilled in the art. The assays are conducted essentially as described herein with respect to the embodiment relating to devising an optimum treatment for an individual patient and the data obtained is analyzed according to the methods described herein which determined final therapeutic indexes. This can indicate which agents or combinations should be further examined in which particular types of tumors.

Uniquely, the present invention provides the capability to include new criteria for bringing an agent into clinical development. Special and systematic consideration can be given to features and observations not heretofore considered for drug discovery. Such new criteria include (but are not limited to): synergism with agents already commonly used whether or not a tumor type is known to be resistant; synergism with agents not commonly used due to tumor resistance; activity at low doses; discovery of salvage regimens for new or existing agents. Importantly, these new criteria can be of such importance for a particular agent that the agent need not be particularly inhibitory. In fact, the new criteria may demonstrate that a conventional single agent is clinically useful even though it has been considered totally inactive.

Further, for screening against a particular type of tumor, the agents or combinations to be screened are assayed against samples of the relevant type of cancer from a plurality of patients in order to obtain overall indication of the effectiveness of the agents or combinations. Effectiveness can be determined by an adjusted comparison with agents or combinations known to be effective against the relevant type of tumor (or against analogous, for example, embryologically analogous, tumors), the adjustment taking into account such new criteria as are described above. For example agents or combinations of known effectiveness can be included in the assays of tumor from a plurality of patients. In any single such assay, the agents or combinations screened are considered effective if their determined therapeutic indexes are substantially similar to the same therapeutic indexes of the known agents or combinations. Then, if the agents or combinations to be screened are effective in a certain fraction of the patients, then they are considered clinically effective. This certain fraction can be, for example, 20% as a preferably threshold to pass beyond Phase II trials.

The known agents or combinations are of the same class, e.g., alkylating agents, taxanes, and the like, as the class of the agents or combinations being screened. Second, it is often advantageous not to adjust final therapeutic indexes for toxicities, including side effects, are considered, or costs, especially where these factors are not definitely known. Preferably, the comparisons also include similar agents, alone or in combination, in order to demonstrate that in structure (as being analogues) or in mechanism of action the test agent achieves superiority in some of the above criteria compared to known agents. Such particular comparisons can lead to further analogue development using new methods of designing agents, once a new target for agent action becomes known.

Clinical Trials

In a further embodiment, the systems or methods of the invention are used in clinical trials to assess the efficacy and/or utility of agents as therapeutic anti-cancer drugs, including, but not limited to, assessing agents or combinations that failed prior clinical trials for the same or a different disorder, assessing agents or combinations for different disorders, assessing agents or combinations at different doses (typically lower such as, for example, 5-10% lower amounts of active component, preferably 10-20% lower, more preferably 40%-50% lower, still more preferably 50-75% lower and even 90% lower, or more) for the same disorders, and assessing new agents or combinations not expected to provide synergistic benefits. In this application, a chemo-sensitivity/resistance assay is conducted as described herein using a variety of tumor types. The potential therapeutic agent or agents are assessed in comparison with therapeutic agents known to have efficacious activity against one or more of the selected tumor types. The raw data is processed as described herein and the results are used to devise protocols for clinical trials of potential therapeutic agents, to devise novel treatment protocols and strategies including salvage strategies, and to support the search for less toxic treatments.

In an alternative, the system or method of the invention is used for efficient selection of patients for clinical trials, such as Phase I or Phase II trials. According to this alternative, only patients with some favorable profile in the in vitro assays herein and analyzed by the methods described herein will actually face the risks of new treatment. An improved risk-benefit ratio results which encourages more patients to consider participating in clinical trial investigation because the chances of a useful outcome improve for each patient. This saves the cost of failed treatments and ensures more compassionate and humane treatment of afflicted patients.

Also, each patient can be considered simultaneously for several (e.g. 6-12) candidate clinical trials, increasing the chances of finding a promising trial for the patient and at the same time returning information to compare the candidate treatments. In addition to expanding patient opportunities, the present invention also makes the development process more efficient. Currently, each agent must proceed through defined steps of, first, trial as a new single agent and, then, trial in combinations with other known agents. For example, if the ex vivo assays indicate that the new agent is either active or inactive while a chosen known agent is at most marginally active but that their combination is synergistically active, then testing can proceed directly to combination testing and unexpected combinations of agents may become available to patients. For another example, after the brief step of Phase I and II toxicity development, testing of a best ex vivo combination against known combinations can proceed directly to Phase III.

The following examples demonstrate the clinical relevance of the ATP-TCA assays for screening new combinations, and the use of embodiments of the present invention to select treatment strategies in individual patients.

### EXAMPLES

### Tumor Responsive Curves

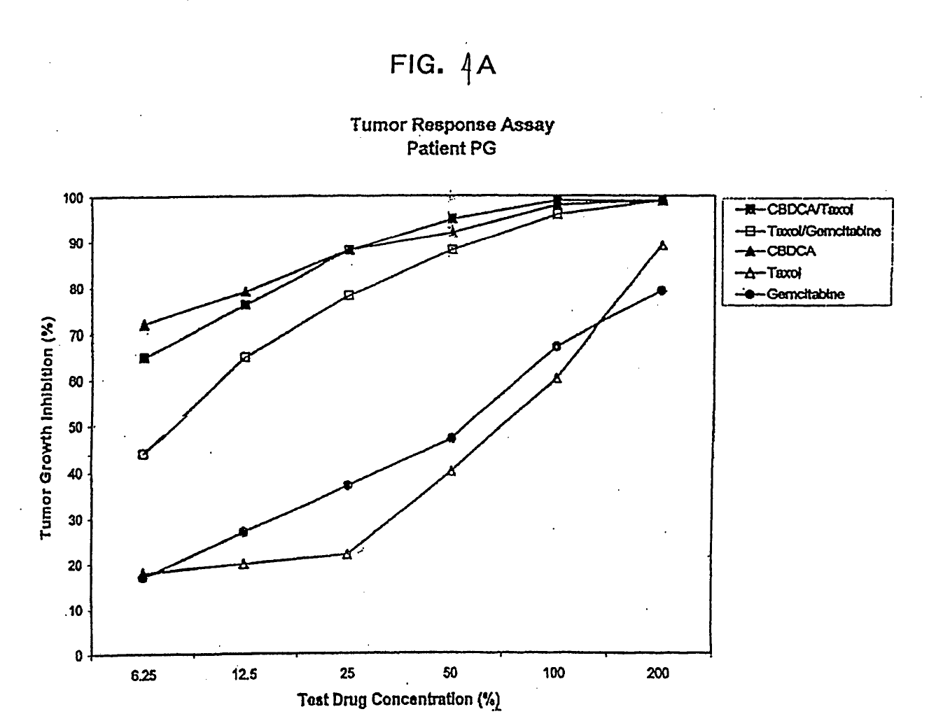

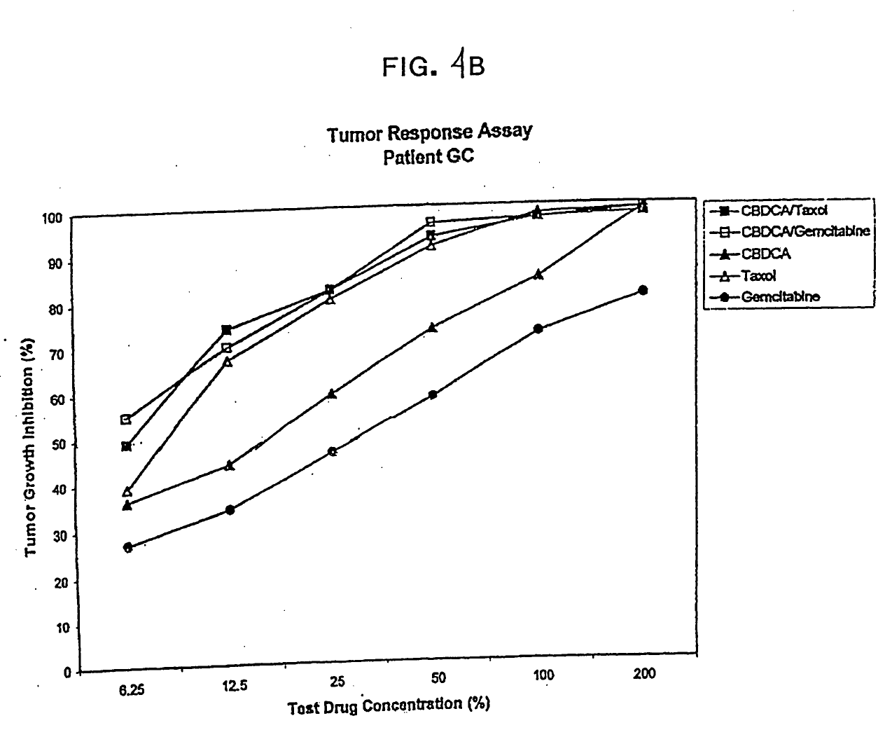

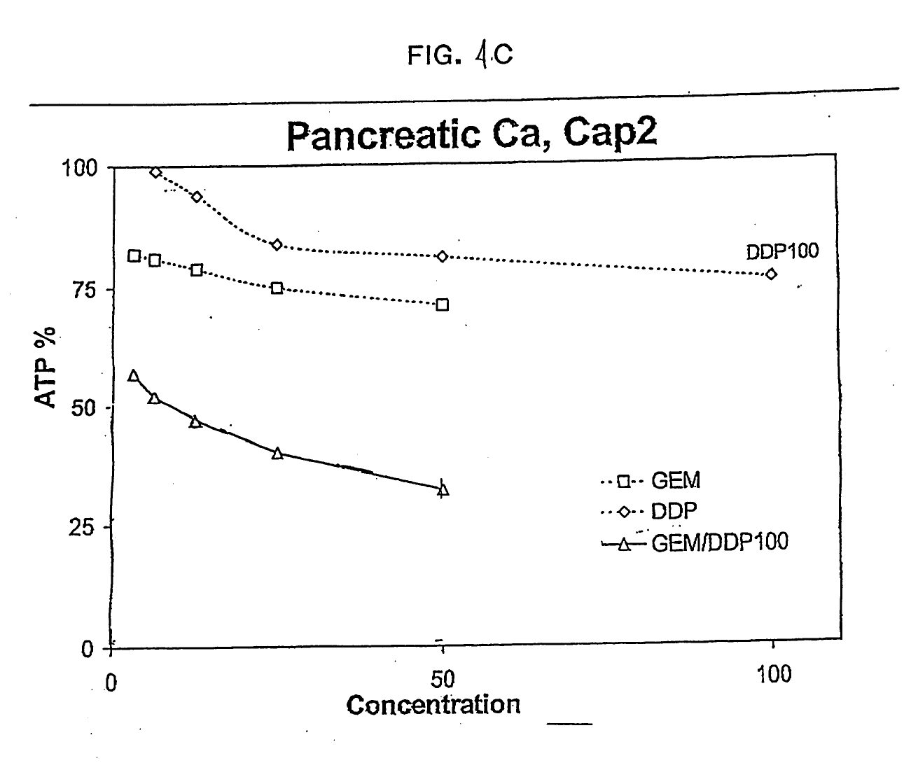

The following illustrates assignment of a Preliminary Rank or Order to a drug(s) or agent(s) based on the results of ATP-TCA assays of patient tumors presented in representative FIGS. 4A-C. All ATP-TCA assays were conducted as described previously herein in detail (see also, e.g., Andreotti et al., 1995, Cancer Res. 55:5276-82; Kurbacher et al., 1996, Breast Cancer Res. Treat., 41:161-70).

FIG. 4A illustrates assay results were obtained with samples of a tumor of patient PG suffering from ovarian cancer. The results of an ATP-TCA assay are graphically presented (FIG. 4A) as a plot of (TDC) Test Drug Concentration (%) versus Tumor Growth Inhibition (%) (i.e., ATP test activity/ATP control×100%). (Carboplatin is abbreviated in FIGS. 4A-B as CBDCA.) The tumor response curves presented in FIG. 4A are ranked as described herein as if they were reference data. The numerical measure used is the AUC-I test. The five curves are ranked by a variation of the basic relation of the present invention which includes an additive error factor into the initial rank or index (for example, 10% or 20%). Alternative, the range from the least to the greatest response can be divided into 10 segments and the curves are assigned to their corresponding segments. The result for the ITI assignments is shown in Table 5.

TABLE 5
Assay Results for Patient PG

| | Initial Therapeutic |
|---|---|
| Agent or Combination | Index |
| Carboplatin + Taxol | 10 |
| Carboplatin | 10 |
| Taxol + Gemcitabine | 8 |
| Gemcitabine | 3 |
| Taxol | 2 |

As is clear from the data presented in this table, although each of Taxol and Gemcitabine alone are not significantly active against this patient's tumor, a combination of Taxol and Gemcitabine is significantly active. In other words, these two agents demonstrate significant synergy in combination. Moreover, the data presented also indicates that the synergistic combination of Taxol and Gemcitabine is almost as active as the single best drug, Carboplatin, alone. Finally, there is no additional benefit to using Taxol in combination with Carboplatin as compared to Carboplatin alone. In view of the minimal activity of Taxol alone, it is difficult to determine whether there was, in fact, any antagonistic interactions of these two agents. Any such antagonism, however, is of little consequence to the final therapeutic indexes because the positive weight of the Taxol-Gemcitabine synergism and the negative weight of the Carboplatin-Taxol combination.

Hence, even in view of the limited information available in this example, the present invention proposes that a reasonable treatment plans for the patient would include either initial Carboplatin alone, followed with a combination of Taxol and Gemcitabine as salvage treatment, if necessary, or sequential alternation of Carboplatin and the combination of Taxol and Gemcitabine. Thereby, by use of the present invention, wasteful use of Taxol, alone or in a toxic combination with Carboplatin is avoided, and the useful and effective regimen of Taxol and Gemcitabine is constructed from two single agents that are weak when used alone. These strategies discovered only by this invention are inaccessible to other prior and current methods.

FIG. 4B illustrates further assay results obtained with samples of a tumor of patient GC also suffering from ovarian cancer. The results of an ATP-TCA assay are graphically presented in FIG. 4B (as described above for FIG. 4A). The data presented in FIG. 4B are indexed as in the previous example, and the results are shown in the Table 6.

TABLE 6
Assay Results for Patient GC

| | Initial Therapeutic |
|---|---|
| Agent or Combination | Index |
| Carboplatin + Taxol | 9 |
| Carboplatin + Gemcitabine | 9 |
| Taxol | 8 |
| Carboplatin | 5 |
| Gemcitabine | 3 |

First, in comparison to previous patient PG, Table 6 indicates that the tumor of patient GC had markedly different responses to the single agents Taxol and Carboplatin. This clearly illustrates the biological heterogeneity of clinically similar tumors. Next, in view of the activity of Carboplatin alone, the lack of additional effects in the combination of this agent with Taxol indicates antagonistic effects. This antagonism is verified by a full analysis of the tumor response curve. Also, although each of Carboplatin and Gemcitabine alone are at best moderately active against this patient's tumor, surprisingly a combination of these two agents is significantly active, as active as the single best drug, Taxol, alone. In other words, these two agents demonstrate significant synergy in combination.

This information leads to the following treatment plan for patient GC. First, treatment could start with Taxol alone, with a combination of Carboplatin and Gemcitabine demonstrated as a useful salvage treatment, if necessary. The combination of Carboplatin and Taxol should be avoided because the antagonism predicts likely clinical failure, or as in this example, the wasting of the conventional use of Taxol.

In view of the toxicities and costs of these agents (well known to those of skill in the art), adjustment of the initial indexes will present clearer choices among the treatment strategies. First, toxicity and cost places the Carboplatin-Gemcitabine combination first, and reserves the more toxic and costly Taxol for rescue. Even if Taxol's index were 3 points higher than the Carboplatin-Gemcitabine combination, it might still be the first choice given the details of a particular patient's case and evaluation. Certainly, because of Taxol's toxicity, it is recommended to assay combination of Taxol and other drugs which can lower the Taxol dose needed. Thereby, by use of the present invention, a wasteful use of Taxol in a combination with Carboplatin a combination which demonstrates no synergistic, or even additive, effect of the two agents, is avoided, and useful and effective salvage regimens are identified, namely Taxol alone or Carboplatin in combination with Gemcitabine.

FIG. 4C illustrates assay results obtained with samples of a tumor of a pancreatic cancer patient, which were obtained using an ATP-TCA and indexed in Table 7 as described for the previous two patients. The only difference is tumor response data is expressed as (%) ATP generated by non-inhibited cells instead of tumor growth inhibition (which is one minus the percent ATP from non-inhibited cells).

TABLE 7
Assay Results for Pancreatic Cancer Sample

| | Initial Therapeutic |
|---|---|
| Agent or Combination | Index |
| Gemcitabine + DDP | 5 |
| Gemcitabine | 3 |
| DDP | 2 |

These results indicate no agent with highly promising activity against this cancer. However, although the two single agents, Gemcitabine and DDP, are not significantly active against this tumor, their combination demonstrates enough synergy so that it is at least active. The only useful treatment is, therefore the combination of Gemcitabine and DDP; no salvage option is indicated. It is noted that the Gemcitabine+DDP combination has been translated in successful clinical treatment development. Evidence this development confirms the synergy in this combination, a synergy only observed in the present invention and not heretofore available to guide treatment development.

Convention EDR-type analysis would, in this case, clearly reject the individual agents tested here and thus would not suggest testing of the combination. Further, even if tested, EDR-type analysis would reject the combination. In contrast, the present invention provides some guarded hope for this patient.

Clinical Results

The following clinical results illustrate aspects of the methods of the present invention. These results clearly demonstrate that in vitro or ex vivo tumor response assays, particularly ATP-TCA assays, correlate with clinical results. This correlation demonstrates exemplifies the foundation on which this invention is based, and also the simpler embodiments.

Optimized use of Paclitaxel and Platinum for Primary Ovarian Cancer

The TP regimen—platinum (Pt) plus and paclitaxel (PCT)—failed to improve patient survival in comparison with Pt alone based protocols in two large phase III trials in primary ovarian cancer (POC). These clinical results demonstrate that combining both agents is often not useful. Nevertheless, TP is the empirical standard primary therapy in the United States.

Both to identify POC patients who can really benefit from the TP regiment and to characterize new active Pt- or PCT-based combinations, an ex vivo model based on the ATP Tumor Chemosensitivy Assay (ATP-TCA) was used. Tumor cells from 140 POC patients were assayed at 6 concentrations of cisplatin (DDP), PCT, gemcitabine (dFdC), doxorubicin (DOX), mitoxantrone (Mx), TP, 4-OH-cyclophosphamide+DDP (CP), DDP+dFdC (PG), DOX+PCT (AT), and MX+PCT (NT).

The assays showed that 24 of 93 POC patients (26%) tested against TP in comparison to CP were significantly more sensitive to TP than to CP. On the other hand, CP produced equal (50/93; 54%) or greater inhibition (19/93; 20%) in the remainder. Of 48 POC patients resistant to both DDP and PCT, 27 (56%) were sensitive to TP. TP was superior to the best single agent in 53% (48/90) when at least one drug was active. Of 47 POC patients tested against TP in comparison to PG, the latter was more effective in 20 (42%). Moreover, PG was active in 62% of POC patients resistant to both DDP and dFdC. In tumors resistant: to DDP, PCT and DOX/MX, AT was active in 64% (42/66) and NT was active in 76% (35/46), illustrating the numerous errors of inferring the results for combinations from single agent testing.

These assay results provided several new treatment strategies involving the use of Pt and PCT in combination with CTX for POC:
(1) Only 26% of patients are likely to benefit from TP in comparison to CP.
(2) Synergy between DDP and PCT occurs, surprisingly, more frequently when both single agents are relatively inactive, the opposite of current expectations.
(3) Adding dFdC, DOX, or MX to the treatment plan overcomes intrinsic PT or taxane resistance.
(4) Although absolute chemoresistance to all of the regimens tested rarely occurred, empirical therapy may sometimes fail to identify the best regimen for an individual tumor depending on the empirical choices considered. The error rate for empirical therapy can range from 26% to 74% in this instance, and the life-threatening error (omission) rate can range from 26% to at least 50%. This illustrates the great impact of the present invention for the nearly 30% of patients who have no benefit from any standard empirical choices, namely a possible treatment is found for at least 20% of the 30% which has not been possible until this invention.
(5) Individualized use of PT and PCT in POC may increase response rates from around 70% to 88% and even to 95% when other active drugs are added as indicated by ATP-TCA.

In conclusion, ATP-TCA testing of major standard drugs for POC substantially increased their cost effectiveness and efficacy by selecting new combinations and treatment sequences.

Mitoxantrone Plus Paclitaxel as a Salvage Regimen for Pretreated Ovarian Cancer

The combination regimen of Mitoxantrone (MX) and Paclitaxel (PCT) had previously been shown by an ATP-based ex vivo chemo-sensitivity assay as effective for the treatment of platinum-refractory recurrent ovarian cancer (ROC). Next, a pilot trial in patients with ROC reproduced the high preclinical activity of this regimen (NT). In view of the success of the pilot, a phase II study was conducted which investigated the NT regimen in heavily pretreated patients with ROC.

A total of 33 patients were recruited, 28 of them regarded to be platinum refractory. Patients had failed 1-5 prior chemotherapies (median 2), in which 21 patients were pretreated with taxanes. All patients with platinum-sensitive disease had failed at least 2 preceding treatments. After secondary failure, 3 NT re-inductions were performed resulting in a total of 36 NT treatments.

NT was applied either on a classical q3w schedule with MX at 8 mg/m² and was applied either on a classical q3w schedule with MX at 8 mg/m² and PCT at 180 mg/m² (NT-I: n=13), or as a dose dense regimen with MX at 6 mg/m² q2w and PCT at 100 mg/m² q1w (NT-II: n=23). Patients received 2-6 NT courses. Grade 3-4 granulocytopenia was the predominate adverse effect seen during 64% of NT courses (NT-I: 49%, NT-II: 77%, p<0.01). However myelosuppression generally resolved spontaneously, or was successfully supported by granulocyte-colony stimulating factor (G-CSF) which was required during 49% of NT cycles (NT-I: 34%, NT-II: 62%, p,0.01).Other severe toxicities occurring without differences between both schedules were grade 3-4 anemia (13%), grade 3-4, thrombocytopenia (5%). Three patients suffered from grade 2 peripheral neuropathy. However, no febrile episodes were seen nor did any pt require hospitalization due to any life-threatening toxicity. Thus at both schedules, the applied dose intensity was 97% for MX and 96% for PCT.

A total of 12 CR (NT-I: n=2, n=4) encountered for an overall response rate (RR) of 69%. Of non-responders, 7 achieved NC (NT-I: n=2, NT-II: n=5) and only 4 (NT-I: n=1, and 13 PR (NT-I: n=l, NT-II: n−3) progressed on NT therapy. The overall survival (GAS) was 20.5 months and the progression free survival (PFS) was 9.5 months. No differences in regard to both OAS and PFS were seen between both NT schedules. (“CR” designates “complete response”, which means all evidence of cancer disappears as the result of treatment. “NC” designates “no change” in clinical disease, which means all evidence of disease indicates no growth and no new complications. “PR” designates “partial response”, which means the tumor is reduced by more than half in diameter or volume. CR is the best clinical benefit and usually foretells prolonged survival. PR is a standard level of clinical benefit and usually foretells improved survival with complication-free quality of life. NC is a real result in patients with active disease and includes tumor reduction by less than 50%.)

In conclusion, NT at both schedules is a highly active salvage regimen for patients with heavily pretreated ROC. These results confirm previous preclinical ATP-TCA ex vivo assays and clinical pilot experiences. Subsequent large-scaled trials with NT in ROC are thus justified by these results. Further, when the clinical response is predicted based on tumor response data for the range of 12.5% -50% TDC instead of 12% -100% (or 200%) TDC, the correlation predictor of responses improve by a p-value log order in three separate cohorts of ovarian cancer patients.

The invention described and claimed herein is not to be limited in scope by the preferred embodiments herein disclosed, since these embodiments are intended as illustrations of several aspects of the invention. Any equivalent embodiments are intended to be within the scope of this invention. Indeed, various modifications of the invention in addition to those shown and described herein will become apparent to those skilled in the art from the foregoing description. Such modifications are also intended to fall within the scope of the appended claims.

Other embodiments and uses of the invention will be apparent to those skilled in the art from consideration of the specification and practice of the invention disclosed herein. All references cited herein, including all publications of any kind such as published U.S. and foreign patents and patent applications, are specifically and entirely incorporated by reference for all purposes. It is intended that the specification and examples be considered exemplary only. Further, none of these references, regardless of how characterized above, is admitted as prior to the invention of the subject matter claimed herein.

1. A method of ranking one or more candidate chemotherapeutic agents or one or more candidate combinations of chemotherapeutic agents for effectiveness against a particular tumor from a patient comprising:
providing both a plurality of sensitivity/resistance assay reference data for a plurality of reference tumors from a plurality of reference patients when each tumor is exposed to one or more of a plurality of reference agents or reference combinations, and also a plurality of clinical response rates experienced with the reference agents and the reference combinations;
providing actual sensitivity/resistance assay data for the particular tumor of the patient when exposed to one or more candidate agents or one or more candidate combinations of agents;
determining initial therapeutic indexes for the candidate agents or the candidate combinations, wherein the initial therapeutic indexes depend on (i) the actual sensitivity/resistance assay data for the particular patient, (ii) the sensitivity/resistance assay reference data, and (iii) the plurality of clinical experiences; and
determining final therapeutic indexes for the candidate agents or the candidate combinations by adjusting the initial therapeutic index in accordance with rules representing clinical goals and expectations for the candidate agents and the candidate combinations.

2. The method of claim 1, wherein the one or more candidate chemotherapeutic agents or one or more candidate combinations of chemotherapeutic agents comprise a plurality of chemotherapeutic agents.

3. The method of claim 2, wherein the plurality of candidate chemotherapeutic agents comprises one or more chemotherapeutic agents that have failed a prior clinical trial.

4. The method of claim 1, wherein the step of determining the final therapeutic indexes further comprises adjusting in accordance with characteristic of the actual sensitivity/resistance assay data.

5. The method of claim 1, wherein at least one of the plurality of reference tumors is clinically similar to the particular tumor of the particular patient.

6. The method of claim 1, wherein at least one of the plurality of reference tumors is similar to the particular tumor if the at least one tumor and the particular tumor have similar embryological origins and histological characteristics.

7. The method of claim 1, wherein at least one of the plurality of reference tumors and the particular tumor originate in the same anatomic organ.

8. The method of claim 1, wherein at least one of the plurality of reference tumors is similar to the particular tumor if at least one reference tumor and the particular tumor have similar molecular characteristics.

9. The method of claim 1, wherein similar molecular characteristics comprise having similar oncogenes or products of oncogenes.

10. The method of claim 1, wherein the steps of the sensitivity/resistance assay comprises performing an assay that measures cellular ATP levels.

11. The method of claim 1, where the candidate agents and the agents of the candidate combinations are clinically known agents.

12. The method of claim 1, wherein the step of determining initial therapeutic indexes further comprises assigning a measure to reference assay data and to actual assay data indicating the responsiveness of a tumor to an agent or combination according to the assay data, whereby quantitative comparisons can be made between the reference assay data and the actual assay data.

13. The method of claim 12, wherein the assigned numerical measures depend only on the assay data for concentrations of less than 100% TDC.

14. The method of claim 12, wherein the assigned numerical measures depend only on the assay data for concentrations of less than 50% TDC.

15. The method of claim 12, wherein the assigned numerical measures depend on an area under a graphical representation of the assay data for an interval of concentrations of less than 100% TDC.

16. The method of claim 12, wherein the assigned numerical measures depend on an area under a graphical representation of the assay data for an interval of concentrations of less than 50% TDC.

17. The method of claim 16, wherein the interval of concentrations is from 6.25% to 50% TDC or from 12.5% to 25% TDC.

18. The method of claim 1, wherein a high therapeutic index signifies a more desirable agent or combination, and wherein the initial therapeutic index of a candidate agent or combination depends in an increasing manner as the clinical experiences indicate that the reference tumors are more responsive to the candidate agent or combination, and in an increasing manner as a comparison of the actual assay data for the candidate agent or combination with the reference assay data indicates that the candidate agent or combination is similar to more responsive reference data.

19. The method of claim 1, wherein the step of determining initial therapeutic indexes further comprises ranking the assay reference data into a plurality of levels according to responsiveness of the tumor assayed to the agent or combination assayed.

20. The method of claim 19, wherein error ranges of the reference data are taken into account by said ranking into said plurality of levels.

21. The method of claim 19, where the plurality of levels comprises 10 levels.

22. The method of claim 19, wherein the step of determining initial therapeutic indexes further comprises determining the rank of the actual assay data for the patient as being the rank of the most similar assay reference data.

23. The method of claim 22, wherein error ranges of the actual assay data reference data are taken into account by the determining of the rank of the actual assay data.

24. The method of claim 22, wherein a low rank signifies greater responsiveness that a higher rank, wherein a high therapeutic index signifies a more desirable agent or combination, and wherein the initial therapeutic index of a candidate agent or combination depends in an increasing manner on the clinical response rate experienced for the candidate agent or candidate combination and in a decreasing manner on the rank of the actual assay data for the candidate agent or candidate combination.

25. The method of claim 24, wherein the initial therapeutic index of a candidate agent or combination is directly proportional to the clinical response rate experienced for the candidate agent or candidate combination and inversely proportional to the rank of the actual assay data for the candidate agent or candidate combination.

26. The method of claim 1, wherein a high therapeutic index signifies a more desirable agent or combination, and wherein the step of determining final therapeutic indexes decreases the initial therapeutic index of an agent or combination if the agent or combination has toxicity that is above average according to a clinical standard, or if the agent or combination has a cost that is above average in view of patient resources, or if the agents in combination have an antagonistic interaction, or if the response data for the agent or combination are atypical.

27. The method of claim 1, wherein a high therapeutic index signifies a more desirable agent or combination, and wherein the step of determining final therapeutic indexes increases the initial therapeutic index of an agent or combination if the agent or combination has toxicity that is below average according to a clinical standard, or if the agent or combination has a cost that is below average in view of patient resources, or if the agents in combination have a synergistic interaction.

28. The method of claim 1, wherein a high therapeutic index signifies a more desirable candidate agent or candidate combination, and wherein the step of determining final therapeutic indexes increases the initial therapeutic index of an agent or combination if strategic uses of the agent or the agents of the combination are identified.

29. The method of claim 26, wherein the strategic uses identified comprise use of an otherwise inactive agent in an active combination.

30. The method of claim 28, wherein the strategic uses identified comprise salvage of an agent.

31. The method of claim 30, wherein salvage of an agent comprise effective use of the agent where previous uses were as part of an ineffective or antagonistic combination.

32. The method of claim 28, wherein the strategic uses identified comprise use of agents of an effective combination in different effective combinations.

33. A method of selecting one or more chemotherapeutic agents or combinations of chemotherapeutic agents likely to be effective against a tumor from a particular patient comprising:
determining final therapeutic indexes for a plurality of candidate agents or candidate combinations of agents by performing the method of claim 1; and
selecting those candidate agents or combinations with the final therapeutic indexes.

34. The method of claim 33, wherein the final therapeutic indexes are the most effective 50% of all indexes.

35. The method of claim 33, wherein the final therapeutic indexes are the most effective 25% of all indexes.

36. The method of claim 33, wherein the final therapeutic indexes are the most effective 10% of all indexes.

37. The method of claim 33, wherein the step of selecting agents with the therapeutic indexes further comprises selecting candidate agents and combinations of candidate agents capable of strategic uses.

38. The method of claim 37, wherein the strategic uses selected comprise use of an otherwise inactive agent in an active combination.

39. The method of claim 37, wherein the strategic uses selected comprise salvage of an agent.

40. The method of claim 39, wherein salvage of an agent comprise effective use of the agent where previous uses were as part of an ineffective or antagonistic combination.

41. The method of claim 37, wherein the strategic uses selected comprise use of agents of an effective combination in different effective combinations.

42. A method of operating a laboratory service to formulate cancer therapy protocols comprising:
determining final therapeutic indexes for a plurality of candidate agents or candidate combinations of agents by performing the method of claim 1 for a patient or a group of patients; and
formulating a clinical treatment protocol for the patient or the groups of patients depending both on the final therapeutic indexes of the candidate agents or candidate combinations and also on the ability, if any, to use a candidate agent or combination in a salvage regimen.

43. A method of treating a particular tumor in a patient comprising:
determining final therapeutic indexes for a plurality of candidate agents or candidate combinations of agents by performing the method of claim 1; and
selecting one or more candidate agents or candidate combinations with the final therapeutic indexes; and
treating the patient with a protocol including the selected agents or combinations.

44. The method of claim 43, wherein the initial therapeutic indexes were statistically comparable in predicting a clinical response rate, and wherein the final therapeutic indexes are the most effective 10% of all indexes.

45. The method of claim 43, wherein the initial therapeutic indexes were statistically comparable in predicting a clinical response rate, and wherein the final therapeutic indexes are the most effective 10-25% of all indexes.

46. The method of claim 43, wherein the initial therapeutic indexes were statistically comparable in predicting a clinical response rate, and wherein the final therapeutic indexes are the most effective 25% of all indexes.

47. The method of claim 43, wherein the initial therapeutic indexes were statistically comparable in predicting a clinical response rate, and wherein the final therapeutic indexes are the most effective 50% of all indexes.

48. A method of determining the effectiveness of a selected agent or a selected combination of agents for a particular type of tumor comprising:
determining a plurality of final therapeutic indexes for the selected agent or selected combination of agents by repetitively performing the method of claim 1 for a plurality of tumors of the particular type from a plurality of patients; and
determining the selected agent or selected combination as effective if the determined final therapeutic ranks for the selected agent or selected combination indicate that the agent or combination are effective against the particular tumor type from the plurality of patients.

49. The method of claim 48, wherein the selected agent or selected combination is determined to be effective if the determined therapeutic indexes indicate that the selected agent or selected combination is more effective that an agent or combination already known to be effective against the particular type of tumor for a sufficient number of patients.

50. The method of claim 49, wherein the sufficient number is such that a chance of clinical benefit is 20%.

51. The method of claim 48, wherein the selected combination is determined as effective only if it further demonstrates synergistic results in comparison with the results of the individual agents of the combination alone.

52. A programmed computer for ranking one or more chemotherapeutic agents or combinations of chemotherapeutic agents for a particular tumor from a patient comprising:
at least one processor and processor-accessible memory; and
input/output devices for inputting to the computer and for outputting from the computer:
(i) wherein the computer has access to one or more databases having a plurality of sensitivity/resistance assay data for a plurality of reference tumors from a plurality of reference patients when each tumor is exposed to one or more of a plurality of reference agents or reference combinations, and also to a plurality of clinical experiences with each of the pluralities of reference agents or reference combinations; and
(ii) wherein instructions loaded in the memory of the computer cause the processor to perform a method with the following steps:
inputting actual sensitivity/resistance assay data for the particular tumor of the patient when exposed to one or more candidate agents or one or more candidate combinations of agents;
accessing the database to retrieve both a plurality of the sensitivity/resistance assay reference data, and the plurality of clinical experiences; and
determining initial therapeutic indexes for the candidate agents or the candidate, wherein the initial therapeutic indexes depend on (i) the actual sensitivity/resistance assay data for the particular patient, (ii) the sensitivity/resistance assay reference data, and (iii) the plurality of clinical experiences;
determining final therapeutic indexes for the candidate agents or the candidate combinations by adjusting the initial therapeutic index in accordance with rules representing clinical goals and expectations for the candidate agents and the candidate combinations; and
outputting the determined final indexes.

53. The programmed computer of claim 52, wherein the determining of final therapeutic indexes further comprises adjusting in accordance with characteristic of the actual sensitivity/resistance assay data.

54. The programmed computer of claim 52, wherein the step of accessing the database further comprises retrieving sensitivity/resistance assay reference data for reference tumors that are clinically similar step to the particular tumor of the patient.

55. The programmed computer of claim 52, wherein the step of accessing further comprises communicating with one or more distributed databases.

56. The programmed computer of claim 52, wherein the step of determining final therapeutic indexes further comprises performing rule-based processing which uses rules expressing the adjustments to the initial therapeutic indexes.

57. The programmed computer of claim 52, wherein the step of determining final therapeutic indexes further comprises performing rule-based processing which uses rules expressing the determination of the initial therapeutic indexes from (i) the actual sensitivity/resistance assay data for the particular patient, (ii) the sensitivity/resistance assay reference data, and (iii) the plurality of clinical experiences.

58. The programmed computer of claim 52, wherein a high therapeutic index signifies a more desirable agent or combination, and wherein the initial therapeutic index of a candidate agent or combination is determined to depend in an increasing manner as the clinical experiences indicate that the reference tumors are more responsive to the candidate agent or combination, and in an increasing manner as a comparison of the actual assay data for the candidate agent or combination with the reference assay data indicates that the candidate agent or combination is similar to more responsive reference data.

59. The programmed computer of claim 52, wherein the one or more chemotherapeutic agents or combinations of chemotherapeutic agents comprise new agents not yet having clinical experiences.

60. The programmed computer of claim 52, wherein the steps of determining initial therapeutic indexes and determining final therapeutic indexes depend on statistical considerations.

61. The programmed computer of claim 52, wherein the step of outputting further comprises outputting the reasons according to which the output indexes were determined.

62. A system for ranking one or more chemotherapeutic agents or combinations of chemotherapeutic agents for a particular tumor from a patient comprising:
at least one programmed computer as claimed in claim 52; and
one or more databases having a plurality of sensitivity/resistance assay data for a plurality of reference tumors from a plurality of reference patients when each tumor is exposed to one or more of a plurality of reference agents or reference combinations, and also to a plurality of clinical experiences with each of the pluralities of reference agents or reference combinations.

63. The system of claim 62, wherein the one or more databases comprise a plurality of distributed databases.

64. The system of claim 62, wherein the one or more databases comprise a single database.

65. A computer readable medium comprising encoded computer instructions for causing a computer to function according to the method of claim 1.

66. A computer-accessible database for providing reference data for the method of claim 1 comprising a computer-readable memory configured with (i) a plurality of sensitivity/resistance assay reference data for a plurality of reference tumors from a plurality of reference patients when each tumor is exposed to one or more of a plurality of reference agents or reference combinations, and (ii) a plurality of clinical response rates experienced with the reference agents and the reference combinations.

67. The database of claim 66, wherein the computer-readable memory is physically distributed.

68. The database of claim 66, wherein the computer-readable memory comprises dynamic memory or secondary storage.

69. The database of claim 66, wherein the computer-readable memory comprises one or more removable computer-readable media.

70. A method of screening one or more candidate chemotherapeutic agents or one or more candidate combinations of chemotherapeutic agents for effectiveness comprising:
providing both a plurality of sensitivity/resistance assay reference data for a plurality of reference agents or reference combinations, and also a plurality of clinical experiences for the reference agents and the reference combinations;
providing actual sensitivity/resistance assay data for the particular tumor of the patient when exposed to one or more candidate agents or one or more candidate combinations of agents; and
determining final therapeutic indexes for the candidate agents or the candidate combinations by final therapeutic indexes depend on (i) the actual sensitivity/resistance assay data, (ii) the sensitivity/resistance assay reference data, the plurality of clinical experiences for the reference agents, and (iv) clinical goals and expectations for the candidate agents and the candidate combinations, wherein the effectiveness is represented by the final therapeutic indexes.

71. The method of claim 70, where the clinical goals and expectations further comprise evidence for synergy of combinations, or reversal of resistance to an agent, or reuse.

72. The method of claim 70, where the reference agents comprise agents of similar structure or mechanism of action.

73. The method of claim 70, wherein the assay reference data and the actual assay data are for concentrations of agents and combinations of agents less than approximately 100% TDC.

74. The method of claim 70, wherein the assay reference data and the actual assay data are for concentrations of agents and combinations of agents less than approximately 50% TDC.

75. The method of claim 70, further comprising a step of determining whether a candidate combination demonstrates synergistic activity by having a final therapeutic index which represents an effectiveness which is a greater than additive combination of the effectiveness of the candidate agents of the combination.

76. The method of claim 70, further comprising a step of determining whether a candidate combination demonstrates antagonistic activity by having a final therapeutic index which; represents an effectiveness which is a less than additive combination of the effectiveness of the candidate agents of the combination.

77. The method of claim 70, further comprising a step of determining whether a candidate combination demonstrates reuse of a particular agent of the combination by having a final therapeutic index which represents effectiveness whereas the final therapeutic index of the particular agent alone or in combinations does not represent effectiveness.

78. The method of claim 70, wherein one or more of the candidate agents or agents of the candidate combinations is an agent having no clinical experience or correlation.

79. The method of claim 70, wherein the final therapeutic index for a candidate agent or combination increases as a comparison of its actual assay data with the reference assay data indicates similarity to reference agents with more effective clinical experiences.

80. The method of claim 70, wherein the final therapeutic index further depends on clinical experiences with the candidate agents or candidate combinations.

81. The method of claim 70, wherein the plurality of clinical experiences comprise a plurality of response rates observed in prior treatments.

82. The method of claim 70, further comprising a step of selecting effective agents for use in clinical trials.
